(19) United States
(12) Patent Application Publication
(10) Pub. No.: US 2024/0322961 A1
(43) Pub. Date: Sep. 26, 2024

(54) METHOD AND DEVICE FOR COMMUNICATION

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG)

(21) Appl. No.: 18/680,255

(22) Filed: May 31, 2024

Related U.S. Application Data
(63) Continuation of application No. PCT/CN2021/135546, filed on Dec. 3, 2021.

(51) Int. Cl. H04L 5/00; H04W 24/10; H04W 84/12

(52) U.S. Cl. CPC H04L 5/0044; H04W 24/10; H04W 84/12

(57) ABSTRACT

A communication method includes: transmitting and/or receiving, by a communication device, a trigger frame carrying sensing measurement related information.

### CROSS-REFERENCE TO RELATED APPLICATION

This application is a Bypass Continuation Application of PCT/CN2021/135546 filed on Dec. 3, 2021, which is incorporated herein by reference in its entirety.

### TECHNICAL FIELD

The present application relates to the field of communications, and in particular, to a method and a device for communication.

### BACKGROUND

Wireless local area networks (WLAN) sensing may include methods and applications of sensing people or objects in the environment by measuring changes in WLAN signals after scattered and/or reflected by people or objects. The WLAN sensing is usually achieved using WLAN signals that comply with wireless communication standards. Improvements are needed in the sensing measurement phase.

### SUMMARY

Embodiments of the present application provide a communication method and a device.

The embodiments of the present application provide a communication method, including: transmitting and/or receiving, by a communication device, a trigger frame carrying sensing measurement related information.

The embodiments of the present application provide a communication method, including: transmitting and/or receiving, by a communication device, a trigger based sensing measurement frame.

The embodiments of the present application provide a communication device, including: a communication unit, configured to transmit and/or receive a trigger frame carrying sensing measurement related information.

The embodiments of the present application provide a communication device, including: a communication unit, configured to transmit and/or receive a trigger based sensing measurement frame.

The embodiments of the present application provide a communication device, including a processor and a memory. The memory is configured to store a computer program, and the processor is configured to invoke and execute the computer program stored in the memory, so that the communication device performs the communication methods described above.

The embodiments of the present application provide a chip for implementing the communication method described above. In some embodiments, the chip includes: a processor, configured to invoke and execute a computer program from a memory, so that a device installed with the chip performs the communication methods.

The embodiments of the present application provide a non-transitory computer readable storage medium, configured to store a computer program, where the computer program, when executed by a device, causes the device to perform the communication methods described above.

The embodiments of the present application provide a computer program product, including computer program instructions, where the computer program instructions cause a computer to perform the communication methods described above.

The embodiments of the present application provide a computer program, where the computer program, when executed by a computer, causes the computer to perform the communication methods described above.

### BRIEF DESCRIPTION OF THE DRAWINGS

FIG. 1 is a schematic diagram showing an application scenario according to embodiments of the present application.

FIGS. 2a to 2j are schematic diagrams showing WLAN sensing and participants.

FIG. 3 is a schematic diagram of flow showing a WLAN sensing session.

FIG. 4a is a schematic diagram showing WLAN sensing measurement parameter negotiation.

FIGS. 4b and 4c are schematic diagrams showing threshold based sensing measurement.

FIG. 5 is a schematic diagram showing measurement setup and measurement instances.

FIG. 6 is a schematic diagram showing a trigger frame based measurement process.

FIGS. 7a, 7b and 7c are schematic diagrams showing trigger frame based measurement processes.

FIG. 8 is an illustrative flowchart showing a communication method according to an embodiment of the present application.

FIG. 9 is an illustrative flowchart showing a communication method according to another embodiment of the present application.

FIG. 10 is a schematic diagram showing a sensing measurement poll trigger frame used to trigger a transmission of an uplink EHT TB PPDU.

FIG. 11 is a schematic diagram showing a sensing measurement poll trigger frame used to trigger a transmission of an uplink HE TB PPDU.

FIG. 12 is a schematic diagram showing a sensing measurement trigger frame used to trigger a transmission of an uplink EHT TB sensing measurement frame (NDP).

FIG. 13 is a schematic diagram showing a sensing measurement trigger frame used to trigger a transmission of an uplink HE TB sensing NDP.

FIG. 14 is a schematic diagram showing an EHT TB sensing NDP format.

FIG. 15 is a schematic diagram showing an HE TB sensing NDP format.

FIG. 16 is a schematic block diagram showing a communication device according to an embodiment of the present application.

FIG. 17 is a schematic block diagram showing a communication device according to an embodiment of the present application;

FIG. 18 is a schematic block diagram showing a communication device according to embodiments of the present application.

FIG. 19 is a schematic block diagram showing a chip according to embodiments of the present application.

FIG. 20 is a schematic block diagram showing a communication system according to embodiments of the present application.

### DETAILED DESCRIPTION

The technical solutions of the embodiments of the present application will be described below with reference to the drawings of the embodiments of the present application.

In the embodiments, a communication method is provided, which includes:
transmitting and/or receiving, by a communication device, a trigger frame carrying sensing measurement related information.

In some embodiments, the sensing measurement related information includes a field for indicating trigger frame type dependent common information.

In some embodiments, the field for indicating the trigger frame type dependent common information includes a field for indicating a sensing trigger frame subtype.

In some embodiments, a value of the field for indicating the sensing trigger frame subtype is a first value, indicating that the trigger frame is a sensing measurement poll trigger frame.

In some embodiments, the sensing measurement poll trigger frame is used to trigger a transmission of an uplink extremely high throughput (EHT) trigger based (TB) physical layer protocol data unit (PPDU).

In some embodiments, the field for indicating the trigger frame type dependent common information is a field in an EHT variant common information field of the sensing measurement poll trigger frame.

In some embodiments, the sensing measurement poll trigger frame is used to trigger a transmission of uplink high efficiency (HE) TB PPDU.

In some embodiments, the field for indicating the trigger frame type dependent common information is a field in an HE variant common information field of the sensing measurement poll trigger frame.

In some embodiments, a value of the field for indicating the sensing trigger frame subtype is a second value, indicating that the trigger frame is a sensing measurement trigger frame.

In some embodiments, the sensing measurement trigger frame is used to trigger a transmission of an uplink EHT TB sensing measurement frame.

In some embodiments, the field for indicating the trigger frame type dependent common information is a field in an EHT variant common information field of the sensing measurement trigger frame.

In some embodiments, the field for indicating the trigger frame type dependent common information further includes: a field for indicating a number of repetitions of an extremely high throughput long training field (EHT-LTF).

In some embodiments, the field for indicating the number of repetitions of the EHT-LTF is used to indicate a number of repetitions of an EHT-LTF of an EHT TB sensing measurement frame triggered by the sensing measurement trigger frame.

In some embodiments, in an EHT variant common information field of the sensing measurement trigger frame, at least one of following becomes a reserved field and/or is set to a third value: a low density parity check code (LDPC) extra symbol segment field, a forward error correction (FEC) pre-filled factor field, or a packet extension (PE) disambiguation field.

In some embodiments, in an EHT variant user information field of the sensing measurement trigger frame, at least one of following becomes a reserved field and/or is set to a fourth value: an uplink forward error correction coding scheme field, an uplink EHT modulation or coding strategy field.

In some embodiments, the sensing measurement trigger frame is used to trigger a transmission of an uplink HE TB sensing measurement frame.

In some embodiments, the field for indicating the trigger frame type dependent common information is a field in an HE variant common information field of the sensing measurement trigger frame.

In some embodiments, the field for indicating the trigger frame type dependent common information further includes: a field for indicating a number of repetitions of an HE-LTF.

In some embodiments, the field for indicating the number of repetitions of the HE-LTF is used to indicate a number of repetitions of the HE-LTF in an HE TB sensing measurement frame triggered by the sensing measurement trigger frame.

In some embodiments, in an HE variant common information field of the sensing measurement trigger frame, at least one of following becomes a reserved field and/or is set to a fifth value: an LDPC extra symbol segment field, an FEC pre-filled factor field, a PE disambiguation field, a Doppler field, an uplink space time block coding field, or a multiple user multiple-input multiple-output (MU-MIMO) HE-LTF mode field.

In some embodiments, in an HE variant user information field of the sensing measurement trigger frame, at least one of following becomes a reserved field and/or is set to a sixth value: an uplink forward error correction coding scheme field, an uplink HE modulation and coding strategy field, or an uplink dual carrier modulation field.

In some embodiments, the field for indicating the trigger frame type dependent common information further includes at least one of:
a field for indicating a sensing measurement setup identifier;
a field for indicating a sensing measurement instance identifier; or
a reserved field.

In some embodiments, the field for indicating the sensing measurement setup identifier is used to identify and indicate a measurement parameter setup to be used by a sensing measurement instance.

In some embodiments, the field for indicating the sensing measurement instance identifier increases by 1 from 0 to 255, and then starts from 0 after reaching 255.

In the embodiments, a communication method is provided, which includes:
transmitting and/or receiving, by a communication device, a trigger based (TB) sensing measurement frame.

In some embodiments, the trigger based sensing measurement frame is used for uplink concurrent channel estimation.

In some embodiments, the trigger based sensing measurement frame is an EHT TB sensing measurement frame, and the EHT TB sensing measurement frame is used for an EHT station (STA).

In some embodiments, the EHT TB sensing measurement frame is in a format of an EHT TB PPDU without a data field.

In some embodiments, a waveform generated by the EHT TB sensing measurement frame is not available for beamforming.

In some embodiments, an EHT-short training field (EHT-STF) field of the EHT TB sensing measurement frame is the same as an EHT-STF field of an EHT TB PPDU.

In some embodiments, duration of a PE field of the EHT TB sensing measurement frame is 4 μs.

In some embodiments, a spatial mapping matrix used by a transmission of an EHT-LTF of the EHT TB sensing measurement frame is determined in at least one of following ways:
in a case where a number of spatial streams (NSS) which are transmitted is equal to a number of transmit chains (NTx) which are transmitted, the spatial mapping matrix being an identity matrix;
in a case where the NSS is less than the NTx, the spatial mapping matrix being an antenna selection matrix without antenna switching; or
in a case where all zero rows are deleted, the spatial mapping matrix being an identity matrix.

In some embodiments, an EHT-LTF of the EHT TB sensing measurement frame supports at least one of following types:
2×EHT-LTF+0.8 μs GI;
2×EHT-LTF+1.6 μs GI; or
4×EHT-LTF+3.2 μs GI.

In some embodiments, a number of EHT-LTF symbols of the EHT TB sensing measurement frame is a product of a normal number of EHT-LTF symbols and a number of repetitions of an EHT-LTF.

In some embodiments, the number of repetitions of the EHT-LTF is carried by a sensing measurement trigger frame, and the sensing measurement trigger frame is used to trigger the EHT TB sensing measurement frame.

In some embodiments, the TB sensing measurement frame is an HE TB sensing measurement frame, and the HE TB sensing measurement frame is used for an HE STA.

In some embodiments, the HE TB sensing measurement frame is in a format of an HE TB PPDU without a data field.

In some embodiments, a waveform generated by the HE TB sensing measurement frame is not available for beamforming.

In some embodiments, an HE-STF field of the HE TB sensing measurement frame is the same as an HE-STF field of an HE TB PPDU.

In some embodiments, duration of a PE field of the HT TB sensing measurement frame is 4 μs.

In some embodiments, a spatial mapping matrix used by a transmission of an HE-LTF of the HE TB sensing measurement frame is determined in at least one of following ways:
in a case where a number of spatial streams (NSS) which are transmitted is equal to a number of transmit chains (NTx) which are transmitted, the spatial mapping matrix being an identity matrix;
in a case where the NSS is less than the NTx, the spatial mapping matrix being an antenna selection matrix without antenna switching; or
in a case where all zero rows are deleted, the spatial mapping matrix being an identity matrix.

In some embodiments, a type supported by an HE-LTF of the HE TB sensing measurement frame is: 2×HE-LTF+1.6 μs GI.

In some embodiments, a number of HE-LTF symbols of the HE TB sensing measurement frame is a product of a normal number of HE-LTF symbols and a number of repetitions of an HE-LTF.

In some embodiments, the number of repetitions of the HE-LTF is carried by a sensing measurement trigger frame, and the sensing measurement trigger frame is used to trigger the HE TB sensing measurement frame.

The technical solutions of the embodiments of the present application can be applied to various communication systems, such as a wireless local area network (WLAN), wireless fidelity (Wireless Fidelity, WiFi) or other communication systems.

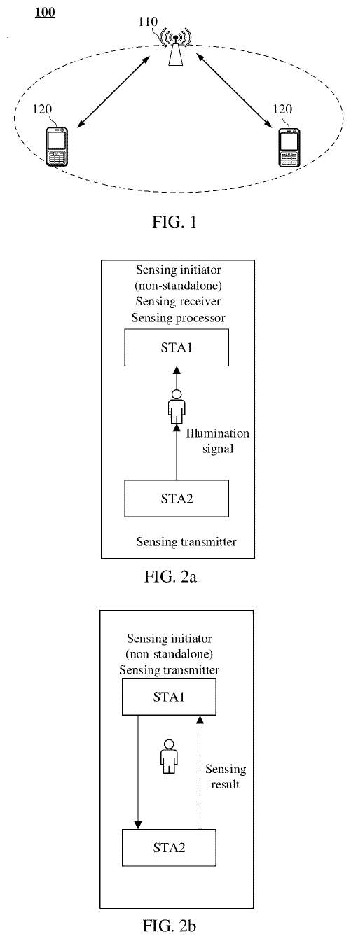

For example, a communication system 100 to which the embodiments of the present application are applied is shown in FIG. 1. The communication system 100 may include an access point (Access Point, AP) 110, and a station (STATION, STA) 120 that accesses a network through the access point 110.

In some scenarios, an AP is also called an AP STA. That is, in a certain sense, the AP is also a kind of STA.

In some scenarios, the STA is also called non-AP STA.

A communication in the communication system 100 may be a communication between the AP and the non-AP STA, a communication between the non-AP STA and the non-AP STA, or a communication between the STA and a peer STA. The peer STA can refer to a device that have a peer communicate with the STA. For example, the peer STA may be an AP or a non-AP STA.

The AP is equivalent to a bridge connecting a wired network and a wireless network, functioning mainly to connect various wireless network clients together and then connect the wireless network to the Ethernet. The AP device can be a terminal device (such as a mobile phone) or a network device (such as a router). The terminal device or the network device has a chip that implements communication functions, such as a WLAN or WiFi chip.

It should be understood that a role of the STA in the communication system is not fixed. For example, in some scenarios, when the mobile phone is connected to the router, the mobile phone is the non-AP STA; and when the mobile phone is used as a hotspot for other mobile phones, the mobile phone acts as the AP.

The AP and the non-AP STA can be devices applied to the Internet of Vehicles, an Internet of Things (IoT) node, a sensor, etc. in the IoT, a smart camera, a smart remote control, a smart water meter, an electricity meter, etc. in the smart home, and a sensor in smart city, etc.

In some embodiments, the non-AP STA may support the 802.11be standard. The non-AP STA can also support various current and future 802.11 family wireless local area networks (WLAN) standards such as 802.11ax, 802.11ac, 802.11n, 802.11g, 802.11b, and 802.11a.

In some embodiments, the AP may be a device supporting the 802.11be standard. The AP may also be a device that supports various current and future 802.11 family WLAN standards, such as 802.11ax, 802.11ac, 802.11n, 802.11g, 802.11b, and 802.11a.

In the embodiments of the present application, the STA may support the WLAN/WiFi technology, which may be a mobile phone (Mobile Phone), a tablet (Pad), a computer, a virtual reality (Virtual Reality, VR) device, an augmented reality (Augmented Reality, AR) device, a wireless device in industrial control, a set-top box, a wireless device in self driving, an in-vehicle communication device, a wireless device in remote medical, a wireless device in smart grid, a wireless device in transportation safety, a wireless device in smart city or smart home, a wireless communication chip/ASIC/SOC/, or the like.

Frequency bands supported by the WLAN technology may include but are not limited to: low frequency bands (e.g., 2.4 GHZ, 5 GHZ, and 6 GHZ), high frequency bands (e.g., 60 GHz).

FIG. 1 exemplarily shows one AP STA and two non-AP STAs. Optionally, the communication system 100 may include multiple AP STAs and other numbers of non-AP STAs, which are not limited in the embodiments of the present application.

It should be understood that terms “system” and “network” are often used interchangeably herein. The term “and/or” in this article is only an association relationship to describe associated objects, indicating that there may be three kinds of relationships. For example, “A and/or B” includes three cases: A exists alone, both A and B exist, and B exist alone. In addition, the character “/” in this article generally indicates that the related objects before and after this character are in an “or” relationship.

It should be understood that the “indicate” mentioned in the embodiments of the present application may mean a direct indication or an indirect indication, or represent that there is an association relationship. For example, A indicates B, which can mean that A directly indicates B, e.g., B can be obtained through A; or it can mean that A indirectly indicates B, e.g., A indicates C, and B can be obtained through C; or it can mean that there is an association relationship between A and B.

The “correspond” mentioned in the embodiments of the present application can mean that there is a direct correspondence or indirect correspondence between two, or it can mean that there is an associated relationship between the two, or it can mean an indicating and being indicated relationship or a configuring and being configured relationship.

In order to facilitate understanding of the technical solutions of the embodiments of the present application, relevant technologies of the embodiments of the present application are described below. The following related technologies can be optionally combined with the technical solutions of the embodiments of the present application, and all of them fall within the scope of protection the embodiments of the present application.

### 1. WLAN Sensing and Participants

WLAN terminals participating in sensing may include roles such as a sensing session initiator (Sensing initiator, which can be referred to as a sensing initiator for short), a sensing session responder (Sensing Responder, which can be referred to as a sensing responder for short), and a sensing signal transmitter (Sensing transmitter, which can be referred to as a sensing transmitter for short), a sensing signal receiver (Sensing receiver, which can be referred to as a sensing receiver for short), and the like.

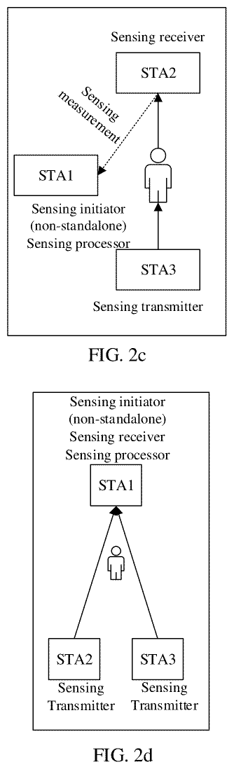

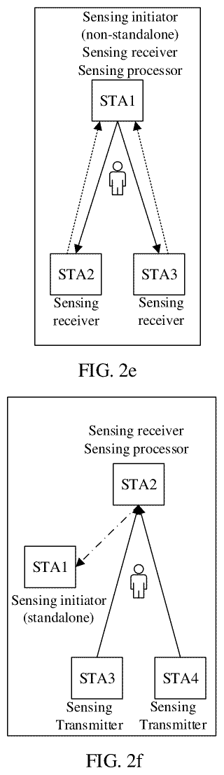

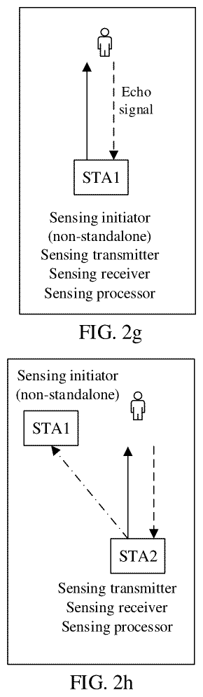

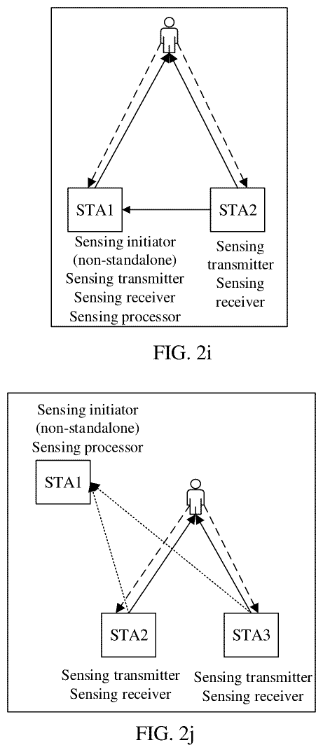

For example, referring to FIG. 2a, an STA1 acts as a sensing initiator (non-standalone), a sensing receiver, and a sensing processor (Sensing processor); and an STA2 acts as a sensing transmitter. Referring to FIG. 2b, an STA1 acts as a sensing initiator (non-standalone) and a sensing transmitter; and an STA2 acts as a sensing receiver and a sensing processor. Referring to FIG. 2c, an STA1 acts as a sensing initiator (standalone) and a sensing processor; an STA2 acts as a sensing receiver; and an STA3 acts as a sensing transmitter. Referring to FIG. 2d, an STA1 acts as a sensing initiator (non-standalone), a sensing receiver and a sensing processor; and an STA2 and an STA3 act as sensing transmitters. Referring to FIG. 2e, an STA1 acts as a sensing initiator (non-standalone), a sensing transmitter, and a sensing processor; and an STA2 and an STA3 act as sensing receivers. Referring to FIG. 2f, an STA1 act as a sensing initiator (standalone), an STA2 acts as a sensing receiver and a sensing processor, and an STA3 and an STA4 act as sensing transmitters. Referring to FIG. 2g, an STA1 acts as a sensing initiator (non-standalone), a sensing transmitter, a sensing receiver, and a sensing processor. Referring to FIG. 2h, an STA1 acts as a sensing initiator (standalone), and an STA2 acts as a sensing transmitter, a sensing receiver and a sensing processor. Referring to FIG. 2i, an STA1 acts as a sensing initiator (non-standalone), a sensing transmitter, a sensing receiver, and a sensing processor; and an STA2 acts as a sensing transmitter and a sensing receiver. Referring to FIG. 2j, an STA1 acts as a sensing initiator (standalone) and a sensing processor, an STA2 acts as a sensing transmitter and a sensing receiver, and an STA3 also acts as a sensing transmitter and a sensing receiver. In FIGS. 2a to 2j, the solid arrows represent an illumination signal, the short-spaced dotted arrows represent sensing measurement, the dot-dash arrows represent sensing results, and the long-spaced dotted arrows represent an echo signal. The illumination signal may also be a sensing measurement signal, which is attenuated and diffracted after being blocked by a person, and a sensing receiving device receives the signal with changed signal characteristics. The illumination signal is reflected by the person or object to generate an echo signal, and the sensing receiving device receives the echo signal to sense changes.

It should be noted that the description of an STA only represents a role of this STA. In FIGS. 2a to 2j and subsequent sensing sessions, measurements and other steps, the number of STAs is not limited. For example, the roles represented by the STA1, the STA2, and the STA3 may each have one or more STAs.

### 2. Overall Procedure of the WLAN Sensing Session

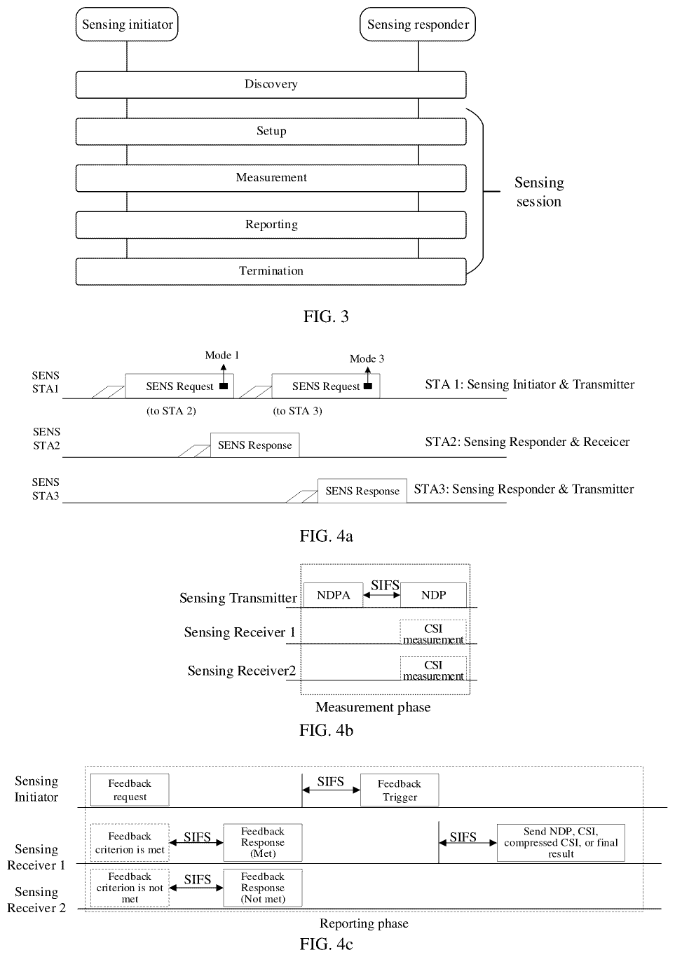

Referring to FIG. 3, a WLAN sensing session includes one or more of the following phases: session setup (Session Setup), sensing measurement setup (Measurement Setup), sensing measurement (Measurement), sensing reporting (Reporting), sensing measurement setup termination (Measurement Setup Termination), and session termination (Session Termination). The WLAN terminal may have one or more roles in one sensing session. For example, a sensing session initiator can be only the sensing session initiator, or it can be a sensing signal transmitter, or it can be a sensing signal receiver, or it can act as the sensing signal transmitter and the sensing signal receiver at the same time.

Session setup phase, in which a sensing session is setup and sensing capability and general sensing parameters of the device are determined.

Sensing measurement setup phase, in which sensing session participants and their roles (including the sensing signal transmitter and the sensing signal receivers) are determined, operating parameters related to the sensing measurement are determined, and the parameters optionally exchanged between terminals.

Sensing measurement phase, in which the sensing measurement is implemented, and the sensing signal transmitter transmits a sensing signal to the sensing signal receivers.

Sensing reporting phase, in which measurement results are reported. Depending on an application scenario, the sensing signal receiver may need to report the measurement results to the sensing session initiator.

Sensing measurement setup termination phase, in which the terminal terminates the measurement corresponding to the measurement setup and cleans up related resources.

Session termination phase, in which the terminal stops the measurement, and the sensing session is terminated.

### 3. WLAN Sensing Measurement Setup Parameter Negotiation

During the sensing measurement setup, terminals may need to negotiate sensing roles and operating parameters with one another, or the terminals may declare their own roles and operating parameters (e.g., through beacon frames or other special frames). For example, referring to FIG. 4a, an SENS STA1 can act as a sensing initiator and a sensing transmitter (Sensing Initiator and Transmitter). An SENS STA2 can act as a sensing responder and a sensing receiver (Sensing Responder and Receiver). An SENS STA3 can act as a sensing responder and a sensing responder transmitter (Sensing Responder and Transmitter). In Mode 1, the terminal SENS STA1 sends a sensing request (SENS Request) to the SENS STA2, and the SENS STA2 sends a sensing response (SENS Response). In Mode 3, the terminal SENS STA1 sends a sensing request (SENS Request) to the SENS STA3, and the SENS STA3 sends a sensing response (SENS Response).

Data volume of sensing measurement result is usually relatively large. For example, data of channel state information (Channel State Information, CSI) measured in one measurement may reach 4K to 40K bits (Bit). To reduce the network load caused by reporting the sensing measurement result, a measurement threshold can be set. If the difference between a current measurement result and the previous measurement result is less than the threshold, the sensing signal receiver reports the sensing result, otherwise it does not report.

For example, as shown in FIG. 4b, in the measurement phase (Measurement phase), the sensing transmitter (Sensing Transmitter) can send a measurement announcement frame (NDP Announcement, NDPA), and send a null data packet (Null Data Packet, NDP) after a short interframe space (Short interframe space, SIFS). A sensing receiver 1 (Sensing Receiver 1) and a sensing receiver 2 (Sensing Receiver 2) can perform CSI measurement (Measurement). As shown in FIG. 4c, in the reporting phase (Reporting phase), the sensing initiator (Sensing Initiator) sends a feedback request (Feedback request). The sensing receiver 1 (Sensing Receiver1) determines that a feedback criterion is met (Feedback criterion is met), and sends a feedback response (Feedback response) indicating that it is met (Met). The sensing receiver 2 (Sensing Receiver 2) determines that the feedback criterion is not met (Feedback criterion is not met), and sends a feedback response (Feedback response) indicating that it is not met (Not met). Then the sensing initiator sends a feedback trigger (Feedback Trigger), and the sensing receiver 1 sends the NDP, the CSI, compressed CSI or a final result.

### 4. Measurement Setup and Measurement Instances

The sensing session initiator can setup multiple groups of measurement parameters by setting the measurement setup (Measurement Setup) process. A group of measurement parameters can be identified by a measurement setup identifier (Measurement Setup ID) and can be applied to multiple measurements (the multiple measurements can be equivalent to a burst group (Burst Group)). Each measurement (which may be equivalent to a burst (Burst)) of another group of measurement parameters may be identified by a measurement instance identifier (Measurement Instance ID), which may be equivalent to a burst (Burst).

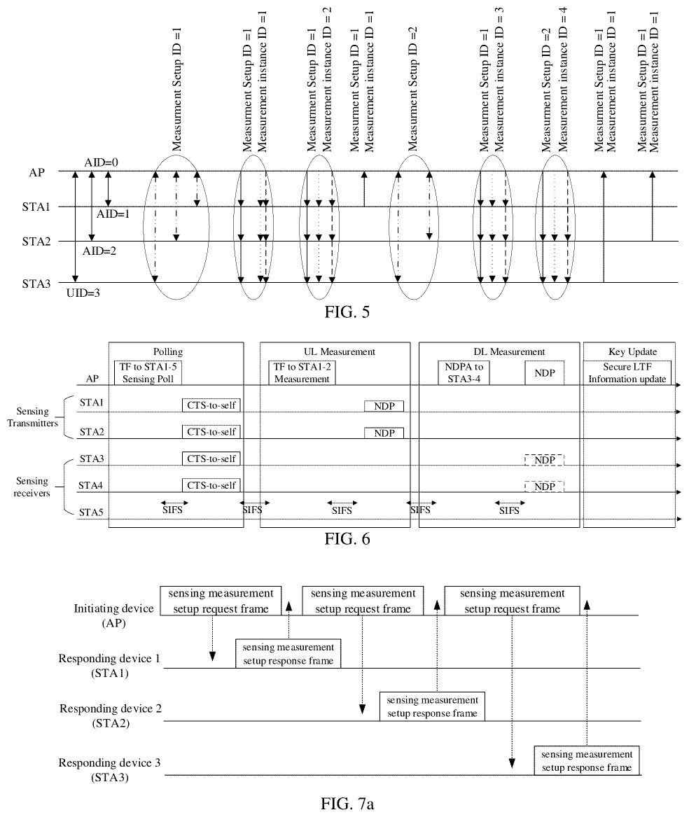

For example, referring to FIG. 5, an AP's association identifier (Association Identifier, AID)=0, an STA1's AID=1, an STA2's AID=2, and an STA3's unassociation identifier (Unassociation Identifier, UID)=3. The AP can establish measurement setup with the STA1, the STA2, and the STA 3 at different time points. The measurement setup ID (Measurement Setup ID)=1. The AP can simultaneously send a sensing measurement poll frame, a sensing announcement frame, and a sensing measurement frame to each of the STA1, the STA2, and the STA 3, in which the measurement setup identify=1 and the measurement instance identify=1. The AP can simultaneously send a sensing measurement poll frame, a sensing announcement frame, and a sensing measurement frame to the STA1, the STA2, and the STA 3, in which the measurement setup identifier=1 and the measurement instance identifier=2. The STA1 can simultaneously send a sensing measurement reporting frame to the AP, to report a sensing measurement result with the measurement setup identifier=1 and the measurement instance identifier=1.

The AP can establish measurement setup with the STA2 and the STA 3 at different time points, in which the measurement setup identifier=2. The AP can simultaneously send a sensing measurement poll frame, a sensing announcement frame, and a sensing measurement frame to the STA1, the STA2, and the STA 3, in which the measurement setup identifier=1 and the measurement instance identifier=3. The AP can simultaneously send a sensing measurement poll frame, a sensing announcement frame, and a sensing measurement frame to the STA2 and the STA 3, in which the measurement setup ID=2 and the measurement instance ID=4. The STA3 can send a sensing measurement reporting frame to the AP, to report a sensing measurement result with the measurement setup identifier=1 and the measurement instance identifier=1. The STA2 can send a sensing measurement reporting frame to the AP, to report a sensing measurement result with the measurement setup ID=1 and the measurement instance ID=1.

### 5. A Trigger Frame Based Measurement Process

A trigger frame based measurement process includes polling (Polling), uplink measurement (Uplink (UL) sensing sounding), downlink measurement (Downlink (DL) sensing sounding) and key update (Key update). As shown in FIG. 6, the STA1 and the STA2 are sensing transmitters, and the STA3, the STA 4, and the STA 5 are sensing receivers.

Polling should always be here to check the availability of responder STAs before performing the actual sensing measurement.

Here, the STA1-4 responds with CTS-to-self to confirm they will participate in upcoming sensing sounding.

The STA5 does not send CTS-to-self back, so the AP will not include the STA5 in upcoming sensing sounding.

UL sensing sounding is optionally present, conditioned on at least one sensing transmitters responds in the polling.

The AP sends a TF (Trigger Frame) to the STA1-2 to solicit NDP packet transmission to do UL sensing sounding.

The NDP from the STA1-2 could be transmitted simultaneously in Multiple-Input Multiple-Output (UL-MIMO)/Orthogonal Frequency Division Multiple Access (UL-OFDMA).

DL sensing sounding is optionally present, conditioned on at least one sensing transmitter receiver in the polling.

The AP sends NDPA+NDP to the STA3-4 to perform DL sensing sounding.

Key update is optionally present if secure LTF info needs to be updated and communicated to STAs.

The updated information can be carried in an action or management frame.

### 6. A Trigger Frame Based Measurement Process

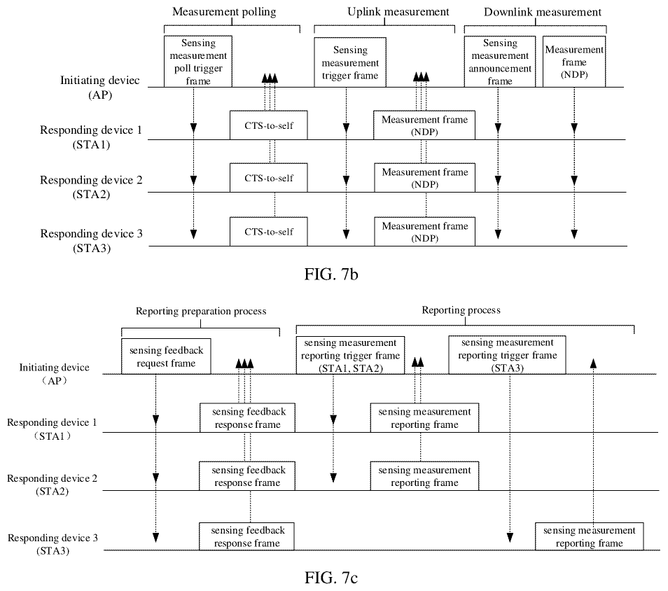

A trigger frame based measurement process includes three phases: a sensing measurement setup phase, a sensing measurement phase, and a sensing measurement reporting phase, as shown in FIG. 7a, FIG. 7b, and FIG. 7c, respectively.

As shown in FIG. 7a, a process of the trigger frame based sensing measurement setup phase may include that: an initiating device, such as an AP, may send a sensing measurement setup request frame to multiple responding devices (for example, responding devices 1, 2, and 3, which are the STA1, the STA12, and the STA3 respectively). The STA1, the STA12, and the STA3 send sensing measurement setup response frames to the AP in different time periods, respectively.

As shown in FIG. 7b, a process of the trigger frame based sensing measurement phase may include that: during a measurement poll process, an initiating device, such as the AP, may simultaneously send a sensing measurement poll trigger frame to multiple responding devices, such as the responding devices 1, 2, and 3, which are the STA1, the STA12, and the STA3, respectively. The STA1, the STA12, and the STA3 respectively send CTS-to-self frames to the AP in a same time period; during an uplink measurement process, the initiating device, such as the AP, sends a sensing measurement trigger frame to the responding devices 1, 2, and 3 respectively in a same time period, and receives feedback measurement frames (such as NDP) of the responding devices; and during a downlink measurement process, the initiating device, such as the AP, sends a sensing measurement announcement frame to the responding devices 1, 2, and 3 respectively in a same time period, and the initiating device, such as the AP, sends a measurement frame to the responding devices 1, 2, and 3 respectively in a same time period. The CTS-to-self frame is a frame with a format defined in relevant standards, and is used here to respond to the sensing poll trigger frame.

As shown in FIG. 7c, a process of the trigger frame based sensing reporting phase may include that: during a reporting preparation process, an initiating device, such as an AP, may send a sensing feedback request frame to multiple responding devices, such as responding devices 1, 2, and 3, which are the STA1, the STA2, and the STA3, respectively, and the STA1, the STA2, and the STA3 respectively send sensing feedback response frames to the AP in a same time period; during a reporting process, the initiating device, such as the AP, sends a sensing measurement reporting trigger frame to the responding devices 1 and 2 respectively in a first time period, and the responding devices 1 and 2 feed back sensing measurement reporting frames to the initiating device in the same time period; the initiating device, such as the AP, sends the sensing measurement reporting trigger frame to the responding device 3 in a second time period, and the responding device 3 feeds back the sensing measurement reporting frame to the initiating device. Regarding the trigger frame based sensing measurement method in the sections 5 and 6 mentioned above, a possible frame format for information interaction can be provided based on the embodiments of the present application.

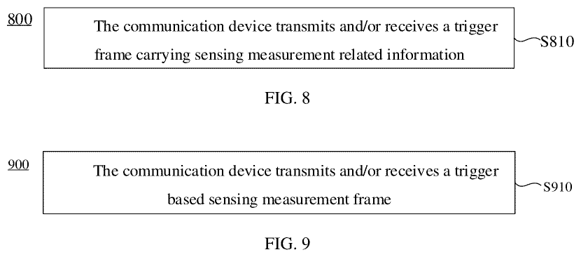

FIG. 8 is an illustrative flowchart showing a communication method 800 according to an embodiment of the present application. This method can optionally be applied to the system shown in FIG. 1, but is not limited thereto. The method includes at least part of the following.

In S810, a communication device transmits and/or receives a trigger frame carrying sensing measurement related information.

In a possible implementation, the communication device may be a first device. The first device may transmit the trigger frame carrying the sensing measurement related information. For example, the first device may transmit the trigger frame carrying sensing measurement related information to a second device. The first device may include an access point station (called as AP for short).

In a possible implementation, the communication device may be the second device. The second device may receive the trigger frame carrying sensing measurement related information. For example, the second device may receive the trigger frame carrying sensing measurement related information from the first device. The second device may include a non-access point station (called as STA for short).

In a possible implementation, the sensing measurement related information includes a field for indicating trigger frame type dependent common information. For example, the field for indicating the trigger frame type dependent common information may be expressed as trigger frame type dependent common information (Trigger Dependent Common Info), used to indicate information applicable to each user in a user information list.

In a possible implementation, the field for indicating the trigger frame type dependent common information includes a field for indicating a sensing trigger frame subtype. For example, the field for indicating the sensing trigger frame subtype may be expressed as a sensing trigger frame subtype (Sensing Subtype).

In a possible implementation, a value of the field for indicating the sensing trigger frame subtype is a first value, indicating that the trigger frame carrying the sensing measurement related information is a sensing poll trigger frame (also called as Poll Sensing Measurement Trigger Frame). For example, the value of 0 for the field for indicating the sensing trigger frame subtype may indicate that the trigger frame is the sensing measurement poll trigger frame. The value of 0 for the field is an example only, and any one value from 0 to 15 or other values can also be used to indicate that the trigger frame is the sensing poll trigger frame.

In the embodiments of the present application, the sensing measurement poll trigger frame can be used in the trigger frame based sensing measurement phase. The first device, such as the AP, sends a sensing measurement poll trigger frame before sending a sensing measurement trigger frame or a sensing announcement frame, so that the number of STAs participating in a sensing measurement instance and their device identifiers can be counted. The STAs participating in this sensing measurement instance will response CTS-to-self frames to the AP according to corresponding resource allocation information in the sensing measurement poll trigger frame. An STA not participating in this sensing measurement instance will not response a CTS-to-self frame to the AP according to the corresponding resource allocation information in the sensing measurement poll trigger frame.

In a possible implementation manner, the sensing measurement poll trigger frame is used to trigger a transmission of an uplink extremely high throughput (Extremely High Throughput, EHT) trigger based (Trigger Based, TB) physical layer protocol data unit (Physical Protocol Data Unit, PPDU). For example, when the sensing measurement poll trigger frame is used to trigger the transmission of the uplink EHT TB PPDU, the 54-th and 55-th bits of an EHT variant common information field of the frame can be set to 0.

In a possible implementation, the field for indicating the trigger frame type dependent common information is a field in the EHT variant common information field of the sensing measurement poll trigger frame.

In a possible implementation, the sensing measurement poll trigger frame is used to trigger a transmission of uplink high efficiency (High Efficiency, HE) TB PPDU. For example, when the sensing measurement poll trigger frame is used to trigger the transmission of the uplink HE TB PPDU, the 54-th and 55-th bits of an HE variant common information field of the frame can be set to 1.

In a possible implementation, the field for indicating the trigger frame type dependent common information is a field in the HE variant common information field of the sensing measurement poll trigger frame.

In a possible implementation, a value of the field for indicating the sensing trigger frame subtype is a second value, indicating that the trigger frame carrying the sensing measurement related information is a sensing measurement trigger frame.

In the embodiments of the present application, the sensing measurement trigger frame may be used in the trigger based sensing measurement phase. The first device, such as the AP, may send the sensing measurement trigger frame to the second device, such as the STA, to trigger the STA to send a trigger based sensing measurement frame (e.g., TB Sensing NDP). Then the AP receives the TB Sensing NDP returned by the STA to complete channel measurement. The STA in an example can be a target STA of the sensing measurement poll trigger frame sent by the AP, and response with the CTS-to-self frame to confirm the STA participating in this sensing measurement instance.

In a possible implementation, the sensing measurement trigger frame is used to trigger a transmission of the uplink EHT TB sensing measurement frame. For example, the EHT TB sensing measurement frame may be an EHT TB sensing null data packet (EHT TB Sensing NDP). When the sensing measurement trigger frame is used to trigger a transmission of the uplink EHT TB Sensing NDP, the 54-th and 55-th bits of an EHT variant common information field of the sensing measurement trigger frame can be set to 0.

In a possible implementation, the field for indicating the trigger frame type dependent common information is a field in the EHT variant common information field of the sensing measurement trigger frame.

In a possible implementation, the field for indicating the trigger frame type dependent common information filed further includes: a field for indicating a number of repetitions of an EHT-LTF (Long Training Field).

In a possible implementation, the field for indicating the number of repetitions of the EHT-LTF is used to indicate number of repetitions of an EHT-LTF of the EHT TB sensing measurement frame triggered by the sensing measurement trigger frame. For example, the sensing measurement trigger frame transmitted by the first device to the second device carries the number of repetitions of the EHT-LTF, which can trigger the second device to transmit the EHT TB sensing measurement frame determined based on the number of repetitions of the EHT-LTF to the first device.

In a possible implementation, in the EHT variant common information field of the sensing measurement trigger frame, at least one of the following becomes a reserved field and/or is set to a third value: a low density parity check code (Low Density Parity Check Code, LDPC) extra symbol segment field, a forward error correction (Forward Error Correction, FEC) pre-filled factor field, or a PE disambiguation field. For example, the LDPC extra symbol segment field, the FEC pre-filled factor field, and the packet extension (PE) disambiguation field each become the reserved field and are set to 0. The third value being 0 is only an example and not a limitation, and the third value can also be other values.

In a possible implementation, in an EHT variant user information field of the sensing measurement trigger frame, at least one of the following becomes a reserved field and/or is set to a fourth value: an uplink forward error correction coding scheme field, an uplink EHT modulation or coding strategy field. For example, the uplink forward error correction coding scheme field and the uplink EHT modulation and coding strategy field each become the reserved field and are set to 0. The fourth value being 0 is only an example and not a limitation, and the fourth value can also be other values.

In a possible implementation, the sensing measurement trigger frame is used to trigger a transmission of an uplink HE TB sensing measurement frame. For example, the HE TB sensing measurement frame may be an HE TB sensing null data packet (HE TB Sensing NDP). When the sensing measurement trigger frame is used to trigger the transmission of uplink HE TB Sensing NDP, the 54-th and 55-th bits of the HE variant common information field of the frame can be set to 1.

In a possible implementation, the field for indicating the trigger frame type dependent common information is a field in an HE variant common information field of the sensing measurement trigger frame.

In a possible implementation, the field for indicating the trigger frame type dependent common information further includes: a field for indicating a number of repetitions of an HE-LTF.

In a possible implementation, the field for indicating the number of repetitions of the HE-LTF is used to indicate a number of repetitions of the HE-LTF in the HE TB sensing measurement frame triggered by the sensing measurement trigger frame. For example, the sensing measurement trigger frame transmitted by the first device to the second device carries the number of repetitions of the HE-LTF, which can trigger the second device to transmit the HE TB sensing measurement frame determined based on the number of repetitions of the HE-LTF to the first device.

In a possible implementation, in the HE variant common information field of the sensing measurement trigger frame, at least one of the following becomes a reserved field and/or is set to a fifth value: an LDPC extra symbol segment field, an FEC pre-filled factor field, an PE disambiguation field, a Doppler field, an uplink space time block coding field, or an MU-MIMO HE-LTF mode field. For example, the LDPC extra symbol segment field, the FEC pre-filled factor field, the PE disambiguation field, the Doppler field, the uplink space time block coding field and the MU-MIMO HE-LTF mode field each become the reserved field and are set to 0. The fifth value being 0 is only an example and not a limitation, and the fifth value may also be other values.

In a possible implementation, in an HE variant user information field of the sensing measurement trigger frame, at least one of the following becomes a reserved field and/or is set to a sixth value: an uplink forward error correction coding scheme field, an uplink HE modulation and coding strategy field, or an uplink dual carrier modulation field. For example, the uplink forward error correction coding scheme field, the uplink HE modulation and coding strategy field, and the uplink dual carrier modulation field each become the reserved field and are set to 0. The sixth value being 0 is only an example and not a limitation, and the sixth value may also be other values.

In a possible implementation, the field for indicating the trigger frame type dependent common information further includes at least one of the following:
a field for indicating a sensing measurement setup identifier;
a field for indicating a sensing measurement instance identifier; or
a reserved filed.

For example, in the sensing measurement poll trigger frame which is used to trigger the transmission of the uplink EHT TB PPDU, the EHT variant common information field includes the field for indicating the trigger frame type dependent common information. The field for indicating the trigger frame type dependent common information includes a field for indicating the sensing trigger frame subtype, a field for indicating a sensing measurement setup identifier, a field for indicating a sensing measurement instance identifier, and a reserved field.

For another example, in the sensing measurement poll trigger frame which is used to trigger the transmission of the uplink HE TB PPDU, the HE variant common information field includes the field for indicating the trigger frame type dependent common information. The field for indicating the trigger frame type dependent common information includes a field for indicating the sensing trigger frame subtype, a field for indicating a sensing measurement setup identifier, a field for indicating a sensing measurement instance identifier, and a reserved field.

For example, in the sensing measurement trigger frame used to trigger the transmission of the uplink EHT TB sensing measurement frame, the EHT variant common information field includes the field for indicating the trigger frame type dependent common information. The field for indicating the trigger frame type dependent common information includes a field for indicating a sensing trigger frame subtype, a field for indicating a sensing measurement setup identifier, a field for indicating a sensing measurement instance identifier, a number of repetitions of an EHT-LTF and a reserved field.

For another example, in the sensing measurement trigger frame used to trigger the transmission of the uplink HE TB sensing measurement frame, the HE variant common information field includes the field for indicating the trigger frame type dependent common information. The field for indicating the trigger frame type dependent common information includes a field for indicating a sensing trigger frame subtype, a field for indicating a sensing measurement setup identifier, a field for indicating a sensing measurement instance identifier, a number of repetitions of an HE-LTF and a reserved field.

In a possible implementation, the field for indicating the sensing measurement setup identifier is used to identify and indicate a measurement parameter setup to be used by a sensing measurement instance.

In a possible implementation, the field for indicating the sensing measurement instance identifier increases by 1 from 0 to 255, and then starts from 0 after reaching 255.

In the embodiments of the present application, various frame formats of the sensing measurement polling trigger frame in the sensing measurement phase are modified to well support sensing measurement.

In the embodiments of the present application, various frame formats of the sensing measurement trigger frame in the sensing measurement phase are modified to better support sensing measurement.

FIG. 9 is a schematic flowchart of a communication method 900 according to an embodiment of the present application. This method can optionally be applied to the system shown in FIG. 1, but is not limited thereto. The method includes at least part of the following.

In S910, the communication device transmits and/or receives a trigger based sensing measurement frame.

In a possible implementation, the communication device may be the first device. The first device may receive the trigger based sensing measurement frame. For example, the first device may receive the trigger based sensing measurement frame from the second device. The first device may include an access point station (called as AP for short).

In a possible implementation, the communication device may be the second device. The second device may transmit the trigger based sensing measurement frame. For example, the second device may transmit the trigger based sensing measurement frame to the first device. The second device may include a non-access point station (called as STA for short).

In a possible implementation, the trigger based sensing measurement frame is used for uplink concurrent channel estimation.

In embodiments of the present application, the trigger based sensing measurement frame (TB Sensing NDP) is used in a trigger frame based sensing measurement phase, and its function is to implement an uplink concurrent channel estimation. The first device, such as the AP, can simultaneously sense states of channels with multiple STAs by transmitting the trigger based sensing measurement frame. The STA in an example may be a target STA of the sensing measurement trigger frame transmitted by the AP.

In a possible implementation, the trigger based sensing measurement frame is an EHT TB sensing measurement frame, and the EHT TB sensing measurement frame is used for an EHT STA. For example, the first device transmits the sensing measurement trigger frame that triggers a transmission of an uplink EHT TB sensing measurement frame to the second device. The second device transmits the EHT TB sensing measurement frame to the first device based on the triggering of the sensing measurement trigger frame.

In a possible implementation, the EHT TB sensing measurement frame is in a format of an EHT TB PPDU without a data (Data) field. For example, the EHT TB sensing measurement frame includes at least one of the following fields: a Legacy Short Training Field (L-STF), an legacy long training field (L-LTF), Legacy signaling (L-SIG), Repeated Legacy signaling (RL-SIG), Universal signaling (U-SIG), an EHT-STF, a packet extension field (PE), or the like. Examples of duration of above fields may include that: duration of the L-STF is 8 μs, duration of the L-LTF is 8 μs, duration of the L-SIG is 4 μs, duration of the RL-SIG is 4 μs, duration of the U-SIG is 8 μs, duration of EHT-STF depends on sizes of a guard interval (GI) and an LTE, and duration of the PE is 4 μs.

In a possible implementation, a waveform generated by the EHT TB sensing measurement frame is not available for beamforming. For example, indication information may be used to indicate that the waveform generated by the EHT TB sensing measurement frame is not available for beamforming.

In a possible implementation, an EHT-STF field of the EHT TB sensing measurement frame is the same as an EHT-STF field of the EHT TB PPDU.

In a possible implementation, duration of the packet extension field of the EHT TB sensing measurement frame is 4 μs.

In a possible implementation, a spatial mapping matrix used by a transmission of an EHT-LTF of the EHT TB sensing measurement frame is determined by using at least one of the following ways:
in a case where a number of spatial streams (Number of Spatial Stream, NSS) which are transmitted is equal to a number of transmit chains (Number of Transmit Chain, NTx) which are transmitted, the spatial mapping matrix being an identity matrix;
in a case where the NSS is less than the NTx, the spatial mapping matrix being an antenna selection matrix without antenna switching; or in a case where all zero rows are deleted, the spatial mapping matrix being an identity matrix.

In a possible implementation, the EHT-LTF of the EHT TB sensing measurement frame supports at least one of the following types:
2×EHT-LTF+0.8 μs GI;
2×EHT-LTF+1.6 μs GI; or
4×EHT-LTF+3.2 μs GI.

Here, the us represents a microsecond and the GI represents the guard interval.

In a possible implementation, the EHT-LTF field may be a deterministic signal that provides a method for estimating an MIMO channel between an output chain and a receive chain of a constellation mapper.

For example, the EHT-LTF field may include the following types: 1×EHT-LTF, 2×EHT-LTF, 4×EHT-LTF.

In a time domain, duration of the 1×EHT-LTF may be 3.2 μs, duration of the 2×EHT-LTF may be 6.4 μs, and duration of the 4×EHT-LTF may be 12.8 μs.

In a frequency domain, examples of subcarrier coefficient of the 1×EHT-LTF are as follows (taking 20 MHz bandwidth as an example):
EHT-LTF (20 MHz)=0, 0, 1, 0, 0, 0, +1, 0, 0, 0, +1, 0, 0, 0, 1, 0, 0, 0, +1, 0, 0, 0, 1, 0, 0, 0, +1, 0, 0, 0, +1, 0, 0, 0, +1, 0, 0, 0, +1, 0, 0, 0, 1, 0, 0, 0, 1, 0, 0, 0, +1, 0, 0, 0, +1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 0, 0, 0, 0, 1, 0, 0, 0, +1, 0, 0, 0, +1, 0, 0, 0, +1, 0, 0, 0, +1, 0, 0, 0, +1, 0, 0, 0, +1, 0, 0, 0, 1, 0, 0, 0, 1, 0, 0, 0, 1, 0, 0, 0, 1, 0, 0, 0, 1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, +1, 0, 0, 0, 1, 0, 0, 0, 1, 0, 0, 0, 1, 0, 0, 0, 1, 0, 0, 0, 1, 0, 0.

Examples of subcarrier coefficient of the 2×EHT-LTF are as follows:
EHT-LTF (20 MHz)=1, 0, 1, 0, 1, 0, +1, 0, +1, 0, 1, 0, +1, 0, 1, 0, 1, 0, 1, 0, 1, 0, +1, 0, 1, 0, +1, 0, 1, 0, 1, 0, +1, 0, +1, 0, 1, 0, +1, 0, +1, 0, +1, 0, +1, 0, +1, 0, 1, 0, +1, 0, 1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, 1, 0, 1, 0, +1, 0, +1, 0, +1, 0, 1, 0, 1, 0, +1, 0, 0, 0, +1, 0, 1, 0, +1, 0, +1, 0, 1, 0, +1, 0, +1, 0, 1, 0, +1, 0, +1, 0, 1, 0, 1, 0, +1, 0, 1, 0, +1, 0, +1, 0, +1, 0, +1, 0, 1, 0, +1, 0, 1, 0, +1, 0, +1, 0, 1, 0, 1, 0, +1, 0, 1, 0, 1, 0, 1, 0, 1, 0, 1, 0, +1, 0, 1, 0, +1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, +1.

Examples of subcarrier coefficient of the 4×EHT-LTF are as follows:
EHT-LTF (20 MHz)=1, 1, +1, 1, +1, 1, +1, +1, +1, 1, +1, +1, +1, 1, 1, +1, 1, 1, 1, 1, 1, +1, +1, 1, 1, 1, 1, +1, +1, 1, +1, 1, +1, +1, +1, +1, 1, +1, 1, 1, +1, +1, 1, +1, +1, +1, +1, 1, 1, +1, 1, 1, 1, +1, +1, +1, +1, 1, +1, +1, 1, 1, 1, 1, +1, 1, 1, +1, +1, 1, +1, 1, 1, 1, 1, +1, 1, +1, 1, 1, 1, 1, 1, 1, +1, +1, 1, 1, 1, 1, 1, +1, 1, 1, +1, +1, +1, 1, +1, +1, +1, 1, +1, 1, +1, 1, 1, 1, 1, 1, +1, +1, +1, 1, 1, 1, +1, 1, +1, +1, +1, 0, 0, 0, 1, +1, 1, +1, 1, +1, +1, 1, +1, +1, +1, 1, 1, +1, 1, 1, +1, 1, +1, 1, +1, +1, +1, 1, +1, +1, +1, 1, 1, +1, 1, 1, 1, 1, 1, +1, +1, 1, 1, 1, 1, 1, 1, +1, 1, +1, 1, 1, 1, 1, +1, 1, +1, +1, 1, 1, +1, 1, 1, 1, 1, +1, +1, 1, +1, +1, +1, +1, +1, +1, +1, 1, +1, +1, 1, 1, 1, 1, +1, 1, 1, +1, +1, 1, +1, 1, 1, 1, 1, +1, 1, +1, 1, 1, +1, +1, +1, +1, 1, 1, +1, +1, +1, +1, +1, 1, +1, +1, 1, 1, 1, +1, 1, 1, 1, +1, 1, +1, 1, +1, +1.

The GI represents a guard interval between orthogonal frequency division multiplexing (Orthogonal Frequency Division Multiplexing, OFDM) symbols, and examples of values of the GI may include: 0.8 μs, 1.6 μs, and 3.2 μs.

In a possible implementation, in the type of the EHT-LTF, the 2×EHT-LTF+0.8 μs GI and the 2×EHT-LTF+1.6 μs GI may be compulsory, and the 4×EHT-LTF+3.2 μs GI may be optional.

In a possible implementation, a number of EHT-LTF symbols of the EHT TB sensing measurement frame is a product of a normal number of EHT-LTF symbols and the number of repetitions of the EHT-LTF. For example, the normal number of the EHT-LTF symbols may be 1, 2, 4, 6, 8, or the like.

In a possible implementation, the number of repetitions of the EHT-LTF is carried by the sensing measurement trigger frame, and the sensing measurement trigger frame is used to trigger the EHT TB sensing measurement frame. For example, the first device transmits the sensing measurement trigger frame carrying the number of repetitions of the EHT-LTF to the second device. In this way, the second device can be triggered to transmit the EHT TB sensing measurement frame determined based on the number of repetitions of the EHT-LTF to the first device. For a frame format of the sensing measurement trigger frame, please refer to the relevant description in the embodiments regarding the sensing measurement trigger frame.

In a possible implementation, the trigger based sensing measurement frame is an HE TB sensing measurement frame, and the HE TB sensing measurement frame is used for an HE STA. For example, the first device transmits the sensing measurement trigger frame that triggers a transmission of an uplink HE TB sensing measurement frame to the second device. The second device transmits the HE TB sensing measurement frame to the first device based on the triggering of the sensing measurement trigger frame.

In a possible implementation, the HE TB sensing measurement frame is in a format of an HE TB PPDU without a data field. For example, the HE TB sensing measurement frame includes at least one of the following fields: an L-STF, an L-LTF, an L-SIG, an RL-SIG, an HE-SIG-A, an HE-STF, an HE-LTF, a PE (packet extension field), or the like. Examples of duration of above fields may include that: the duration of the L-STF is 8 μs, the duration of the L-LTF is 8 μs, the duration of the L-SIG is 4 μs, the duration of the RL-SIG is 4 μs, the duration of the HE-SIG-A is 8 μs, there can be multiple HE-STFs and duration of each HE-STF is 8 μs, the duration of the HE-LTF is 8 μs, and the duration of the PE is 4 μs.

In a possible implementation, a waveform generated by the HE TB sensing measurement frame is not available for beamforming. For example, indication information may be used to indicate that the waveform generated by the HE TB sensing measurement frame is not available for beamforming.

In a possible implementation, an HE-STF field of the HE TB sensing measurement frame is the same as an HE-STF field of the HE TB PPDU.

In a possible implementation, duration of the packet extension field of the HE TB sensing measurement frame is 4 μs.

In a possible implementation, a spatial mapping matrix used by a transmission of an HE-LTF of the HE TB sensing measurement frame is determined by using at least one of the following ways:
in a case where a number of spatial streams (NSS) which are transmitted is equal to a number of transmit chains (NTx) which are transmitted, the spatial mapping matrix being an identity matrix;
in a case where the NSS is less than the NTx, the spatial mapping matrix being an antenna selection matrix without antenna switching; or
in a case where all zero rows are deleted, the spatial mapping matrix being an identity matrix.

In a possible implementation, a type supportable by the HE-LTF of the HE TB sensing measurement frame is: 2×HE-LTF+1.6 μs GI. Here, the us represents the microsecond and the GI represents the guard interval.

In a possible implementation, the HE-LTF field may be a deterministic signal that provides a method for estimating an MIMO channel between an output chain and a receive chain of a constellation mapper.

For example, the HE-LTF field may include the following types: 1×HE-LTF, 2×HE-LTF, 4×HE-LTF.

In a time domain, duration of the 1×HE-LTF may be 3.2 μs, duration of the 2×HE-LTF may be 6.4 μs, and duration of the 4×HE-LTF may be 12.8 μs.

In a frequency domain, examples of subcarrier coefficient of the 1×HE-LTF are as follows (taking 20 MHz bandwidth as an example):
HE-LTF (20 MHz)=0, 0, 1, 0, 0, 0, +1, 0, 0, 0, +1, 0, 0, 0, 1, 0, 0, 0, +1, 0, 0, 0, 1, 0, 0, 0, +1, 0, 0, 0, +1, 0, 0, 0, +1, 0, 0, 0, +1, 0, 0, 0, 1, 0, 0, 0, 1, 0, 0, 0, +1, 0, 0, 0, +1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 0, 0, 0, 0, 1, 0, 0, 0, +1, 0, 0, 0, +1, 0, 0, 0, +1, 0, 0, 0, +1, 0, 0, 0, +1, 0, 0, 0, +1, 0, 0, 0, 1, 0, 0, 0, 1, 0, 0, 0, 1, 0, 0, 0, 1, 0, 0, 0, 1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, +1, 0, 0, 0, 1, 0, 0, 0, 1, 0, 0, 0, 1, 0, 0, 0, 1, 0, 0, 0, 1, 0, 0.

Examples of subcarrier coefficients for 2×HE-LTF are as follows:
HE-LTF (20 MHz)=1, 0, 1, 0, 1, 0, +1, 0, +1, 0, 1, 0, +1, 0, 1, 0, 1, 0, 1, 0, 1, 0, +1, 0, 1, 0, +1, 0, 1, 0, 1, 0, +1, 0, +1, 0, 1, 0, +1, 0, +1, 0, +1, 0, +1, 0, +1, 0, 1, 0, +1, 0, 1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, 1, 0, 1, 0, +1, 0, +1, 0, +1, 0, 1, 0, 1, 0, +1, 0, 0, 0, +1, 0, 1, 0, +1, 0, +1, 0, 1, 0, +1, 0, +1, 0, 1, 0, +1, 0, +1, 0, 1, 0, 1, 0, +1, 0, 1, 0, +1, 0, +1, 0, +1, 0, +1, 0, 1, 0, +1, 0, 1, 0, +1, 0, +1, 0, 1, 0, 1, 0, +1, 0, 1, 0, 1, 0, 1, 0, 1, 0, 1, 0, +1, 0, 1, 0, +1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, +1.

Examples of subcarrier coefficients for 4×HE-LTF are as follows:
HE-LTF (20 MHz)=1, 1, +1, 1, +1, 1, +1, +1, +1, 1, +1, +1, +1, 1, 1, +1, 1, 1, 1, 1, 1, +1, +1, 1, 1, 1, 1, +1, +1, 1, +1, 1, +1, +1, +1, +1, 1, +1, 1, 1, +1, +1, 1, +1, +1, +1, +1, 1, 1, +1, 1, 1, 1, +1, +1, +1, +1, 1, +1, +1, 1, 1, 1, 1, +1, 1, 1, +1, +1, 1, +1, 1, 1, 1, 1, +1, 1, +1, 1, 1, 1, 1, 1, 1, +1, +1, 1, 1, 1, 1, 1, +1, 1, 1, +1, +1, +1, 1, +1, +1, +1, 1, +1, 1, +1, 1, 1, 1, 1, 1, +1, +1, +1, 1, 1, 1, +1, 1, +1, +1, +1, 0, 0, 0, 1, +1, 1, +1, 1, +1, +1, 1, +1, +1, +1, 1, 1, +1, 1, 1, +1, 1, +1, 1, +1, +1, +1, 1, +1, +1, +1, 1, 1, +1, 1, 1, 1, 1, 1, +1, +1, 1, 1, 1, 1, 1, 1, +1, 1, +1, 1, 1, 1, 1, +1, 1, +1, +1, 1, 1, +1, 1, 1, 1, 1, +1, +1, 1, +1, +1, +1, +1, +1, +1, +1, 1, +1, +1, 1, 1, 1, 1, +1, 1, 1, +1, +1, 1, +1, 1, 1, 1, 1, +1, 1, +1, 1, 1, +1, +1, +1, +1, 1, 1, +1, +1, +1, +1, +1, 1, +1, +1, 1, 1, 1, +1, 1, 1, 1, +1, 1, +1, 1, +1, +1.

The GI represents the guard interval between the OFDM symbols, and examples of values of the GI may include: 0.8 μs, 1.6 μs, and 3.2 μs.

In a possible implementation, a number of HE-LTF symbols of the HE TB sensing measurement frame is a product of a normal number of HE-LTF symbols and number of repetitions of the HE-LTF. For example, the normal number of the HE-LTF symbols may be 1, 2, 4, 6, 8, or the like.

In a possible implementation, the number of repetitions of the HE-LTF is carried by the sensing measurement trigger frame, and the sensing measurement trigger frame is used to trigger the HE TB sensing measurement frame. For example, the first device transmits the sensing measurement trigger frame carrying the number of repetitions of the HE-LTF to the second device. In this way, the second device can be triggered to transmit the HE TB sensing measurement frame determined based on the number of repetitions of the HE-LTF to the first device. For a frame format of the sensing measurement trigger frame, please refer to the relevant description in the embodiments regarding the sensing measurement trigger frame.

In a possible implementation, the method of an embodiment can be used in combination with the method 800 of the above embodiments. The trigger frame carrying the sensing measurement related information in the method 800 is used for triggering, and the trigger based sensing measurement frame in this embodiment is used for sensing measurement. For example, after the first device, such as the AP, transmits the sensing measurement poll trigger frame using at least one frame format in above method 800 to the second device, such as the STA, the second device transmits CTS-to-self to the first device. Then, after the first device, such as the AP, transmits the sensing measurement trigger frame using at least one frame format in the method 800 to the second device, such as the STA, the second device transmits the trigger based sensing measurement frame using at least one frame format of this embodiment to the first device.

The embodiments of the present application provide various frame formats of the sensing measurement frame in the sensing measurement phase, which can well support sensing measurement.

Referring to FIG. 3, an overall procedure of WIFI sensing includes phases such as discovery, setup, measurement, reporting, and termination. The frame formats provided by the embodiments of the present application mainly involves the measurement phase. Examples of the frame formats provided by the embodiments of the present application are described below.

In the sensing measurement phase, at least one of the following frame formats may be provided: a sensing measurement poll trigger frame, a sensing measurement trigger frame, or a trigger based sensing measurement frame. Contents of each of the three frame formats are described in detail below.

### 1. The Sensing Measurement Poll Trigger Frame

The sensing measurement poll trigger frame is used in the trigger frame based sensing measurement phase, and its function is to count a number of STAs participating in a sensing measurement instance and their device identifiers before the AP transmits the sensing measurement trigger frame or sensing announcement frame. The STAs participating in this sensing measurement instance will response CTS-to-self frames to the AP according to corresponding resource allocation information of the sensing measurement poll trigger frame. An STA that does not participate in this sensing measurement instance will not response a CTS-to-self frame to the AP according to the corresponding resource allocation information in the sensing measurement poll trigger frame.

The reason why a poll operation is performed before a start of the sensing measurement instance is that, as time changes, a STA that participated in the last sensing measurement instance may leave AP's coverage area or be busy with other communication tasks during the next sensing measurement, resulting in unable to participate in this sensing measurement instance.

The sensing measurement poll trigger frame can be used to trigger the transmission of uplink EHT TB PPDU or the transmission of uplink HE TB PPDU. When the sensing measurement poll trigger frame is used to trigger the transmission of the uplink EHT TB PPDU, the 54-th and 55-th bits of the common information field are both set to 0. When the sensing measurement poll trigger frame is used to trigger the transmission of the uplink HE TB PPDU, the 54-th and 55-th bits of the common information field are both set to 1.

When the sensing measurement poll trigger frame is used to trigger the transmission of the uplink EHT TB PPDU, the sensing measurement poll trigger frame includes the EHT variant common information field and the EHT variant user information field. When the sensing measurement poll trigger frame is used to trigger the transmission of the uplink HE TB PPDU, the sensing measurement poll trigger frame includes the HE variant common information field and the HE variant user information field.

### 1.1 the Sensing Measurement Poll Trigger Frame Used to Trigger the Transmission of the Uplink EHT TB PPDU

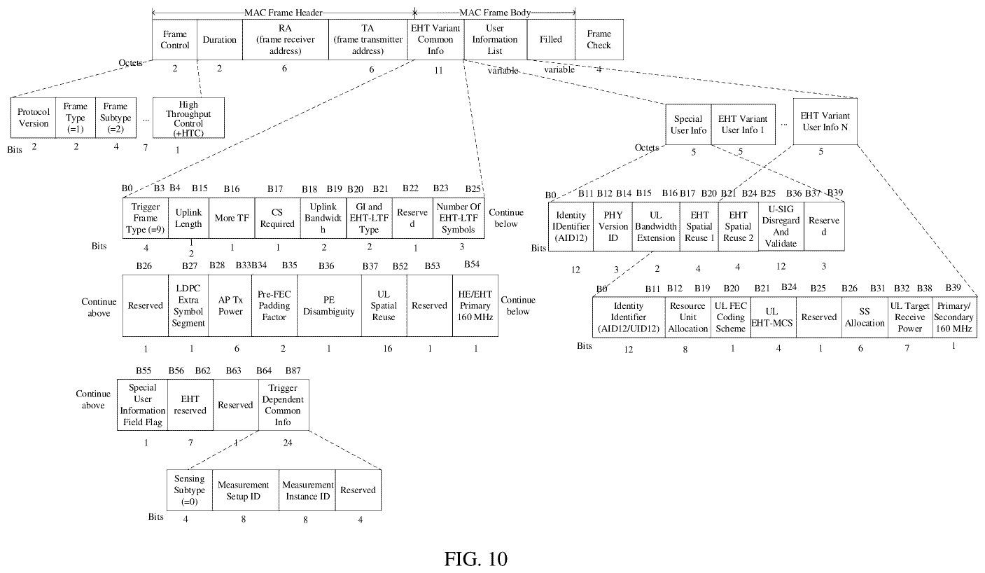

As shown in FIG. 10, a sensing measurement poll trigger frame (Sensing Poll Trigger frame) used to trigger the transmission of the uplink EHT TB PPDU is provided. This is a new trigger frame, where:
a frame type (Type): a value of 1 indicating that the frame is a control frame;
a frame subtype (Subtype): a value of 2 indicating that the frame is a trigger frame;
EHT variant common information (EHT variant Common Info): applicable to information of the STA identified by each user information in the user information list.

The following describes the various fields included in the EHT variant common information.

Trigger frame type (Trigger Type): a value of 9 indicating that the frame is the sensing trigger frame (any one of reserved values 9 to 15 may be used to indicate that the frame is the sensing trigger frame).

Uplink length (UL Length): indicating a value of an L-SIG LENGTH field of the uplink EHT TB PPDU triggered by the trigger frame.

Whether there being more trigger frames (More TF): indicating whether there are other trigger frames to be transmitted after the trigger frame is transmitted. A value is 1 for yes and 0 for no, or 0 for yes and 1 for no.

Whether carrier sensing being required (CS Required): indicating that an STA identified by a user information field needs to use energy detection (Energy Detection, ED) to sense medium, and consider medium states and network allocation vector (Network Allocation Vector, NAV) to determine whether to respond. A value is 1 for yes and 0 for no, or 0 for yes and 1 for no.

Uplink bandwidth (UL BW): together with an uplink bandwidth extension (UL BW Extension) subfield in a “special user information” field, this field indicating a bandwidth used by the EHT TB PPDU. Examples of possible values and their meanings are shown in Table 1.

TABLE 1
Coding meanings of an uplink bandwidth field
and an uplink bandwidth extension subfield

| Uplink | | EHT TB PPDU |
|---|---|---|
| bandwidth | Uplink bandwidth extension | bandwidth |
| 0 | 0 | 20 MHz |
| 0 | 1 | Reserved |
| 0 | 2 | Reserved |
| 0 | 3 | Reserved |
| 1 | 0 | 40 MHz |
| 1 | 1 | Reserved |
| 1 | 2 | Reserved |
| 1 | 3 | Reserved |
| 2 | 0 | 80 MHz |
| 2 | 1 | Reserved |
| 2 | 2 | Reserved |
| 2 | 3 | Reserved |
| 3 | 0 | Reserved |
| 3 | 1 | 160 |
| 3 | 2 | 320-1 |
| 3 | 3 | 320-2 |

GI and EHT-LTF type (GI And EHT-LTF Type): indicating a type of a guard interval (Guard Interval, GI) and a type of an EHT-LTF (Long Training Field) that are used by the uplink EHT TB PPDU triggered by the trigger frame. Examples of possible values and their meanings are shown in Table 2.

TABLE 2
Meanings of a field of the guard interval and EHT-LTF type

| Value | Guard interval and EHT-LTF type |
|---|---|
| 0 | 1 × EHT-LTF + 1.6 μs GI |
| 1 | 2 × EHT-LTF + 1.6 μs GI |
| 2 | 4 × EHT-LTF + 3.2 μs GI |
| 3 | Reserved |

The number of EHT-LTF symbols (Number Of EHT-LTF Symbols): indicating the number of EHT-LTF symbols used in the uplink EHT TB PPDU triggered by the trigger frame. Examples of possible values and their meanings are shown in Table 3.

TABLE 3
Meanings of a field of the number of EHT-LTF symbols

| Value | Number of EHT-LTF symbols |
|---|---|
| 0 | 1 EHT-LTF |
| 1 | 2 EHT-LTF |
| 2 | 4 EHT-LTF |
| 3 | 6 EHT-LTF |
| 4 | 8 EHT-LTF |
| 5-7 | Reserved |

LDPC extra symbol segment (LDPC Extra Symbol Segment): indicating a state of the low density parity check (LDPC) extra symbol segment. A value of 1 indicates that there is the LDPC extra symbol segment in the uplink EHT TB PPDU triggered by the trigger frame, and a value of 0 indicates that there is no LDPC extra symbol segment in the uplink EHT TB PPDU triggered by the trigger frame.

AP transmitting power (AP Tx Power): indicating an AP combined transmitting power on a transmitting antenna connector of all antennas used to transmit trigger PPDUs, in units of dBm/20 MHz.

FEC pre-filled factor (Pre-FEC Padding Factor): indicating the FEC pre-filled factor of the uplink EHT TB PPDU triggered by the trigger frame. Examples of possible values and their meanings are shown in Table 4.

TABLE 4
Meaning of a field of the FEC pre-filled factor

| Value | FEC pre-filled factor |
|---|---|
| 0 | 4 |
| 1 | 1 |
| 2 | 2 |
| 3 | 3 |

PE disambiguation (PE Disambiguity): indicating the PE disambiguation of the uplink EHT TB PPDU triggered by the trigger frame. If a formula (1) is met, a value of this field is 1; and if the formula (1) is not met, the value of this field is 0.

$${T}_{PE} + 4 \times ( ⌈ \frac{TXTIME - SignalExtension - 20}{4} ⌉ - ( \frac{TXTIME - SignalExtension - 20}{4} ) ) \geq {T}_{SYM} \qquad ( 1 )$$

Here, T_{PE} is a length of a PE field, T_{SYM} is a symbol length of a data field, TXTIME is a transmitting time of a data packet, SignalExtension is 0 if NO_SIG_EXTN in a vector (TXVECTOR) is true, and SignalExtension is aSignalExtension if NO_SIG_EXTN in TXVECTOR is false.

Uplink spatial reuse (UL Spatial Reuse): indicating a value of a spatial reuse field of the HE-SIG-A field of the uplink EHT TB PPDU triggered by the trigger frame.

HE/EHT primary 160 MHZ (HE/EHT P160): indicating the uplink TB PPDU triggered by the trigger frame is an HE TB PPDU or an EHT TB PPDU in the primary 160 MHz. A value of 0 represents the EHT TB PPDU, and a value of 1 represents the HE TB PPDU.

Special user information field flag (Special User Information Field Flag): indicating whether the trigger frame includes a special user information field. A value of 0 indicates that the special user information field is included, and a value of 1 indicates that the special user information field is not included. The value of this field in the EHT variant common information field is always 0, indicating that the trigger frame including the EHT variant common information field includes the special user information field. When the sensing measurement poll trigger frame is used to trigger the transmission of the uplink EHT TB PPDU, the 54-th bit (HE/EHT P160 field) and the 55-th bit (Special User Info Field Flag field) of the EHT variant common information field are both set to 0.

The sensing trigger frame may further include a trigger frame type dependent common information field.

Trigger frame type dependent common information (Trigger Dependent Common Info): indicating information applicable to each user in the user information list. For example, this field may include the following fields:
(1) sensing trigger frame subtype (Sensing Subtype): a value of 0 indicating that the frame is a sensing measurement poll trigger frame (Poll Sensing Measurement Trigger Frame) (any one of the values 0 to 15 may be used). Other values may also be used to indicate that the frame is the sensing poll trigger frame;
(2) sensing measurement setup ID (Measurement Setup ID) field: indicating a measurement setup identifier, which identifies a measurement parameter setup to be used by the measurement instance;
(3) sensing measurement instance ID (Measurement Instance ID) field: indicating a measurement instance identifier, which increases by 1 from 0 to 255, and then starts again from 0 after reaching 255.

The trigger frame type dependent common information field may further include the reserved field.

The above are the fields of the EHT variant common information. The user information list of the sensing measurement trigger frame and fields included therein will be described as follow.

User information list (User Info List): including a collection including zero or more user information fields. For example, the field includes the following fields.

Special user information (Special User Info): this field not carrying the specific user information, but carrying common information other than the EHT variant common information field.

Identity identifier (AID12): a value being a fixed value of 2007, which identifies the user information field as the special user information field.

PHY version identifier: indicating a PHY version of the TB PPDU triggered by the trigger frame (excepting theHE TB PPDU). Examples of possible values and their meanings are shown in Table 5.

TABLE 5
Meaning of a field of the PHY version identifier

| Value | PHY version identifier |
|---|---|
| 0 | EHT |
| 1-7 | Reserved |

UL bandwidth extension (UL Bandwidth Extension): together with the uplink bandwidth field in the EHT variant common information field, indicating a bandwidth of the TB PPDU obtained by the EHT STA triggered by the trigger frame. Examples of possible values and their meanings are shown in Table 1.

EHT spatial reuse 1 (EHT Spatial Reuse 1): carrying a value of a spatial reuse 1 field in the U-SIG field of the EHT TB PPDU triggered by the trigger frame.

EHT spatial reuse 2 (EHT Spatial Reuse 2): carrying a value of a spatial reuse 2 field in the U-SIG field of the EHT TB PPDU triggered by the trigger frame.

U-SIG disregard and validate (U-SIG Disregard And Validate): carrying a value of a disregard (Disregard) and validate (Validate) field in the U-SIG field of the EHT TB PPDU triggered by the trigger frame.

EHT variant user information (EHT variant User Info): carrying information for a specific STA.

Identity identifier (AID12/UID12): an identifier of the terminal.

Resource unit allocation (RU Allocation): resource unit allocation information for the terminal.

Uplink forward error correction soding scheme (UL FEC Coding Type): indicating a channel coding type used by the uplink EHT TB PPDU triggered by the trigger frame. A value of 0 indicates a BCC coding, and a value of 1 indicates an LDPC coding.

Uplink EHT modulation and coding strategy (UL EHT-MCS): indicating a modulation and coding strategy used by the uplink EHT TB PPDU triggered by the trigger frame.

Spatial stream allocation (SS Allocation): indicating spatial stream allocation information used by the uplink EHT TB PPDU triggered by the trigger frame.

Uplink target receive power (UL Target Receive Power): indicating an expected power of a received signal averaged by each antenna measured on the antenna connector of the AP for the uplink EHT TB PPDU triggered by the trigger frame.

Primary/Secondary 160 MHz (PS160): indicating a resource unit allocation scheme by cooperated with a resource unit allocation field.

For the sensing trigger frame, the special user information field or the EHT variant user information field does not include a trigger frame type dependent user information field (Trigger Dependent User Info field).

### 1.2 Sensing Measurement Poll Trigger Frame for Triggering the Transmission of Uplink HE TB PPDU

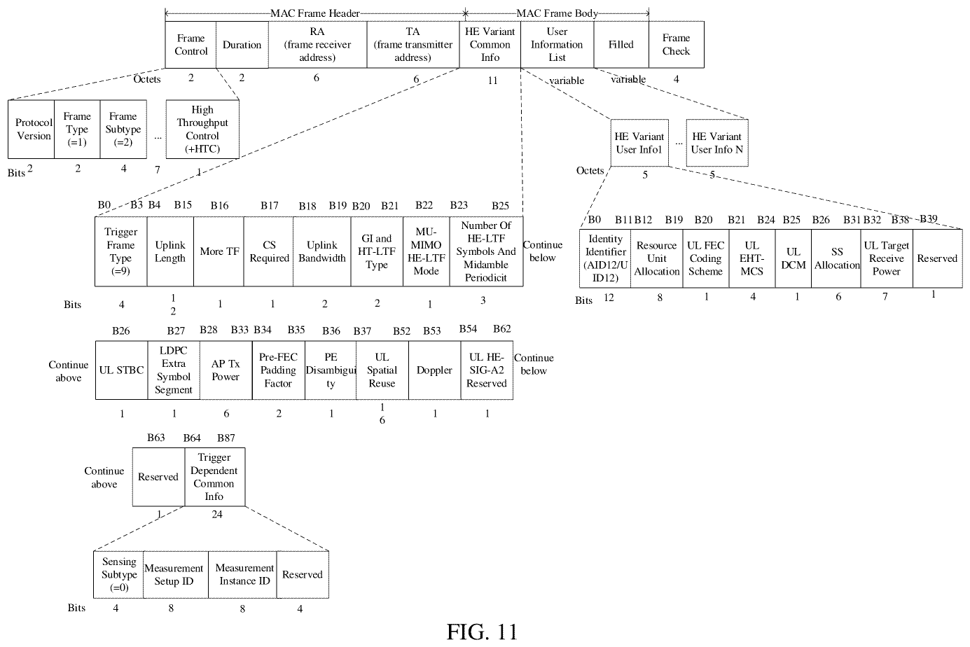

As shown in FIG. 11, a sensing measurement poll trigger frame (Sensing poll trigger frame) for triggering the transmission of uplink HE TB PPDU is provided. This is a new trigger frame, where:
A frame type (Type): a value of 1 indicating that the frame is a control frame.
A frame subtype (Subtype): a value of 2 indicating that the frame is a trigger frame.
HE variant common information (HE variant Common Info): applicable to information of the STA identified by each user information in the user information list.

The following describes the fields included in the HE variant common information.

Trigger frame type (Trigger Type): a value of 9 indicating that the frame is the sensing trigger frame (any one of reserved values 9 to 15 may be used to indicate that the frame is the sensing trigger frame).

Uplink length (UL Length): indicating a value of the L-SIG LENGTH field of the uplink HE TB PPDU triggered by the trigger frame.

Whether there being more trigger frames (More TF): indicating whether there are other trigger frames to be transmitted after the trigger frame is transmitted. A value is 1 for yes and 0 for no, or 0 for yes and 1 for no.

Uplink bandwidth (UL BW): indicating a bandwidth used by the uplink HE TB PPDU triggered by the trigger frame. Examples of possible values and their meanings are shown in Table 6.

TABLE 6
Meaning of a field of the uplink bandwidth

| Value | Uplink bandwidth |
|---|---|
| 0 | 20 MHz |
| 1 | 40 MHz |
| 2 | 80 MHz |
| 3 | 80 + 80 MHz or 160 MHz |

GI and HE-LTF Type (GI And HE-LTF type): indicating a type of guard interval (Guard Interval, GI) and a type of HE-LTF (Long Training Field) that are used by the uplink HE TB PPDU triggered by the trigger frame. Examples of possible values and their meanings are shown in Table 7.

TABLE 7
Meanings of a field of the guard interval and HE-LTF type

| Value | Guard interval and HE-LTF type |
|---|---|
| 0 | 1 × HE-LTF + 1.6 μs GI |
| 1 | 2 × HE-LTF + 1.6 μs GI |
| 2 | 4 × HE-LTF + 3.2 μs GI |
| 3 | Reserved |

MU-MIMO HE-LTF mode: when the GI and HE-LTF field indicates 2×HE-LTF+1.6 μs GI or 4×HE-LTF+3.2 μs GI, this field indicating that all bandwidth resources are used and are allocated to HE-LTF modes used by HE TB PPDUs of multiple non-AP STAs. In addition, this field is used to indicate a single stream pilot frequency HE-LTF mode. Examples of possible values and their meanings are shown in Table 8.

TABLE 8
Meaning of a field of the MU-MIMO HE-LTF mode

| Value | MU-MIMO HE-LTF mode |
|---|---|
| 0 | HE single stream pilot frequency HE-LTF mode |
| | (HE single stream pilot HE-LTF mode) |
| 1 | HE masked HE-LTF mode (HE masked HE-LTF |
| | sequence mode) |

A number of HE-LTF Symbols and midamble periodicity (Number Of HE-LTF Symbols And Midamble Periodicity): when a Doppler field is 0, this field indicating the number of HE-LTF symbols used by the uplink HE TB PPDU triggered by the trigger frame. Examples of possible values and their meanings are shown in Table 9.

TABLE 9
Meaning of a field of the number of HE-LTF symbols

| Value | Number of HE-LTF symbols |
|---|---|
| 0 | 1 HE-LTF |
| 1 | 2 HE-LTF |
| 2 | 4 HE-LTF |
| 3 | 6 HE-LTF |
| 4 | 8 HE-LTF |
| 5-7 | Reserved |

When the Doppler field is 1, this field indicates the number of HE-LTF symbols and midamble periodicity used by the uplink HE TB PPDU triggered by the trigger frame. Examples of possible values and their meanings are shown in Table 10.

TABLE 10
Meaning of a field of the number of HE-
LTF symbols and midamble periodicity

| | Number of HE-LTF symbols and midamble |
|---|---|
| Value | periodicity |
| 0 | 1 HE-LTF and 10 symbol period |
| 1 | 2 HE-LTF and 10 symbol period |
| 2 | 4 HE-LTF and 10 symbol period |
| 4 | 1 HE-LTF and 20 symbol period |
| 5 | 2 HE-LTF and 20 symbol period |
| 6 | 4 HE-LTF and 20 symbol period |
| 3, 7 | Reserved |

Uplink space time block coding (UL STBC, Space Time Block Coding): indicating whether the HE TB PPDU triggered by the trigger frame uses the space time block coding. A value of 1 indicates that the space time block coding is used, and a value of 0 indicates that the space time block coding is not used.

LDPC extra symbol segment (LDPC Extra Symbol Segment): indicating s state of the low density parity check (LDPC) extra symbol segment. A value of 1 indicates that there is the LDPC extra symbol segment in the uplink HE TB PPDU triggered by the trigger frame, and a value of 0 indicates that there is no LDPC extra symbol segment in the uplink HE TB PPDU triggered by the trigger frame.

AP transmitting power (AP Tx Power): indicating an AP combined transmitting power on the transmitting antenna connector of all antennas used to transmit trigger PPDUs, in units of dBm/20 MHz.

FEC pre-filled factor (Pre-FEC Padding Factor): indicating the FEC pre-filled factor of the uplink EHT TB PPDU triggered by the trigger frame. Examples of possible values and their meanings are shown in Table 11.

TABLE 11
Meaning of a field of the FEC pre-filled factor

| Value | FEC pre-filled factor |
|---|---|
| 0 | 4 |
| 1 | 1 |
| 2 | 2 |
| 3 | 3 |

PE disambiguation (PE Disambiguity): indicating the PE disambiguation of the uplink HE TB PPDU triggered by the trigger frame. If a formula (2) is met, a value of this field is 1; and if the formula (2) is not met, the value of this field is 0.

$${T}_{PE} + 4 \times ( ⌈ \frac{TXTIME - SignalExtension - 20}{4} ⌉ - ( \frac{TXTIME - SignalExtension - 20}{4} ) ) \geq {T}_{SYM} \qquad ( 2 )$$

Here, T_{PE} is a length of a PE field, T_{SYM} is a symbol length of a data field, TXTIME is a packet transmitting time, SignalExtension is 0 if NO_SIG_EXTN in TXVECTOR is true, and SignalExtension is aSignalExtension if NO_SIG_EXTN in TXVECTOR is false.

Uplink spatial reuse (UL Spatial Reuse): indicating a value of a spatial multiplexing field of the HE-SIG-A field of the uplink HE TB PPDU triggered by the trigger frame.

Doppler: indicating whether there is a midamble in the HE TB PPDU triggered by the trigger frame. A value of 1 indicates that it exists, and a value of 0 indicates that it does not exist.

Uplink HE-SIG-A2 reserved (UL HE-SIG-A2 Reserved): carrying a value of the reserved field in an HE-SIG-A2 subfield in HE TB PPDUs triggered by the trigger frame. Uplink HE-SIG-A2 reserved fields are all set to 1.

Trigger frame type dependent common information (Trigger Dependent Common Info): indicating information applicable to each user in the user information list. For example, this field may include the following fields:
(1) sensing trigger frame subtype (Sensing Subtype): a value of 0 indicating that the frame is a sensing poll trigger frame (also called as Poll Sensing Measurement Trigger Frame) (any one of the values 0 to 15 may be used); Other values may also be used to indicate that the frame is the sensing poll trigger frame;
(2) sensing measurement setup ID (Measurement Setup ID) field: indicating a measurement setup identifier, which identifies a measurement parameter setup to be used by the measurement instance.
(3) sensing measurement instance ID (Measurement Instance ID) field: indicating a measurement instance identifier, which increases by 1 from 0 to 255, and then starts again from 0 after reaching 255.

The trigger frame type dependent common information field may further include the reserved field.

The above are the fields of the EHT variant common information, the user information list of the sensing measurement trigger frame and fields it includes will be described as follow.

User information list (User Info List): including a collection including zero or more user information fields. For example, the field includes the following fields.

HE variant user information (HE variant User Info): carrying information for a specific STA.

Resource unit allocation (RU Allocation): resource unit allocation information for the terminal.

Uplink forward error correction coding scheme (UL FEC Coding Type): indicating a channel coding type used by the uplink HE TB PPDU triggered by the trigger frame. A value of 0 indicates a BCC coding, and a value of 1 indicates an LDPC coding.

Uplink HE modulation and coding strategy (UL HE-MCS): indicating a modulation and coding strategy used by the HE TB PPDU triggered by the trigger frame.

Uplink dual carrier modulation (UL DCM): indicating whether the HE TB PPDU triggered by the trigger frame uses a dual carrier modulation. A value of 1 indicates that the dual carrier modulation is used, and a value of 0 indicates that the dual carrier modulation is not used.

Spatial stream allocation (SS Allocation): indicating spatial stream allocation information used by the uplink HE TB PPDU triggered by the trigger frame.

Uplink target receive power (UL Target Receive Power): indicating an expected power of a received signal averaged by each antenna measured on the antenna connector of the AP for the uplink HE TB PPDU triggered by the trigger frame.

### 2. Sensing Measurement Trigger Frame

The sensing measurement trigger frame is used in the trigger frame based sensing measurement phase, and its function is for the AP to trigger the STA to transmit the trigger based sensing measurement frame (TB Sensing NDP), and then the AP receives the TB Sensing NDP to complete the channel measurement. The STA here can be the target STA of the sensing measurement poll trigger frame transmitted by the AP, and response to the CTS-to-self frame to confirm the STA participating in this sensing measurement instance.

The sensing measurement trigger frame can be used to trigger the transmission of the uplink EHT TB Sensing NDP or the transmission of the uplink HE TB Sensing NDP.

When the sensing measurement trigger frame is used to trigger the transmission of the uplink EHT TB Sensing NDP, the 54-th and 55-th bits of the common information field are both set to 0. When the sensing measurement trigger frame is used to trigger the transmission of the uplink HE TB Sensing NDP, the 54-th and 55-th bits of the common information field are both set to 1.

When the sensing measurement trigger frame is used to trigger the transmission of the uplink EHT TB Sensing NDP, the sensing measurement trigger frame includes the EHT variant common information field and the EHT variant user information field. When the sensing measurement trigger frame is used to trigger the transmission of the uplink HE TB Sensing NDP, the sensing measurement trigger frame includes the HE variant common information field and the HE variant user information field.

### 2.1 Sensing Measurement Trigger Frame Used to Trigger the Transmission of the Uplink EHT TB Sensing NDP

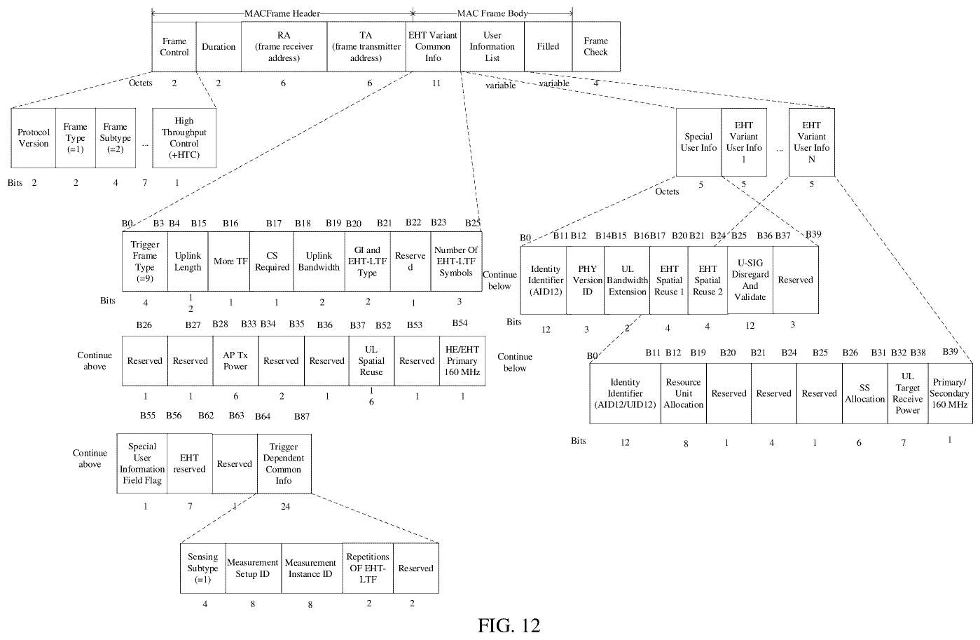

As shown in FIG. 12, a sensing measurement trigger frame (Sensing Measurement Trigger frame) used to trigger the transmission of the uplink EHT TB Sensing NDP is provided. This is a new trigger frame.

In the EHT variant common information field, the trigger frame type dependent common information field may be included. The trigger frame type dependent common information field may include: at least one of a sensing trigger frame subtype (Sensing Subtype), a sensing measurement setup ID, a sensing measurement instance ID, a number of repetitions of the EHT-LTF, or the reserved field.

Sensing subtype (Sensing Subtype): a value of 1 indicating that a subtype of the sensing trigger frame is the sensing measurement trigger frame. Other values may also be used to indicate that the subtype of the sensing trigger frame is the sensing measurement trigger frame.

Compared with the sensing measurement poll trigger frame used to trigger the transmission of the uplink EHT TB PPDU in the section 1.1 above, three fields of the LDPC extra symbol segment, the FEC pre-filled factor, and the PE disambiguation in the EHT variant common information (EHT variant Common Info) field of the sensing measurement trigger frame become the reserved field and are all set to 0. The “a number of repetitions of the EHT-LTF” field is newly added to the trigger frame type dependent common information field to indicate the number of repetitions of the EHT-LTF in the EHT TB Sensing NDP triggered by the sensing measurement trigger frame.

Compared with the sensing measurement poll trigger frame used to trigger the transmission of the uplink EHT TB PPDU in the section 1.1 above, in the EHT variant user information (EHT variant User Info) field of the sensing measurement trigger frame, two fields of the uplink forward error correction coding scheme and the uplink EHT modulation and coding strategy become the reserved field and are both set to 0.

For values and meanings of other fields, please refer to corresponding fields in the sensing measurement poll trigger frame used to trigger the transmission of the uplink EHT TB PPDU in the section 1.1 above.

### 2.2 Sensing Measurement Trigger Frame Used to Trigger the Transmission of Uplink HE TB Sensing NDP

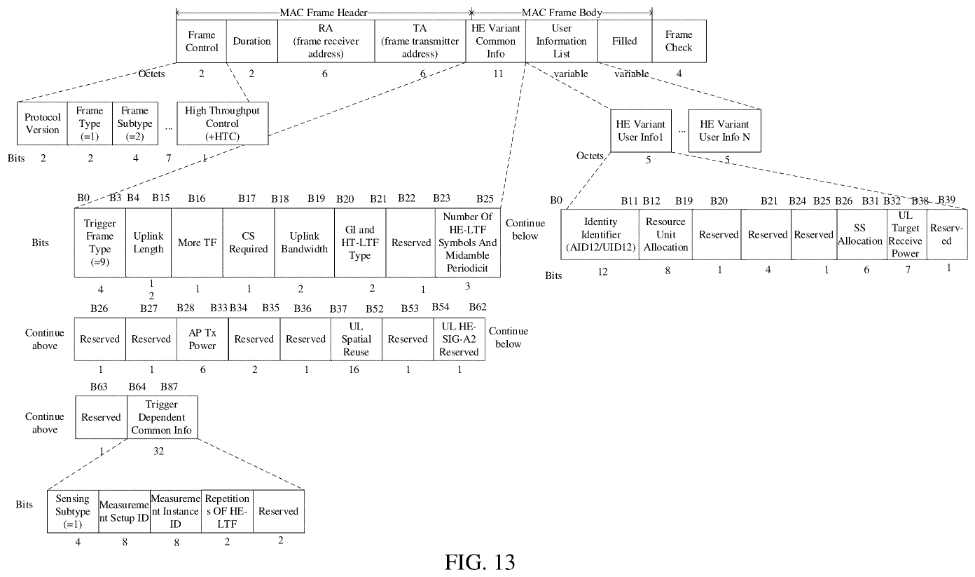

As shown in FIG. 13, a sensing measurement trigger frame (Sensing Measurement Trigger frame) used to trigger the transmission of the uplink HE TB Sensing NDP is provided. This is a new trigger frame.

In the HE variant common information field, the trigger frame type dependent common information field may be included. The trigger frame type dependent common information field may include: at least one of a sensing trigger frame subtype (Sensing Subtype), a sensing measurement setup ID, a sensing measurement instance ID, a number of repetitions of the HE-LTF, or a reserved field.

Sensing subtype (Sensing Subtype): a value of 1 indicating that a subtype of the sensing trigger frame is the sensing measurement trigger frame. Other values may also be used to indicate that the subtype of the sensing trigger frame is the sensing measurement trigger frame.

Compared with the sensing measurement poll trigger frame used to trigger the transmission of the uplink HE TB PPDU in the section 1.2 above, in the EHT variant user information (EHT variant User Info) field of the sensing measurement trigger frame, six fields of the LDPC extra symbol segment, the FEC pre-filled factor, the PE disambiguation, the Doppler, the uplink space time block coding, and the MU-MIMO HE-LTF mode become the reserved field and are all set to 0. The “a number of repetitions of the HE-LTF” field is newly added to the trigger frame type dependent common information field to indicate the number of repetitions of the HE-LTF in the HE TB Sensing NDP triggered by the sensing measurement trigger frame.

Compared with the sensing measurement poll trigger frame used to trigger the transmission of uplink HE TB PPDU in the section 1.2 above, in the HE variant user information (HE variant User Info) field of the sensing measurement trigger frame, three fields of the uplink forward error correction coding scheme, the uplink HE modulation and coding strategy and the uplink dual carrier modulation become the reserved field and are all set to 0.

For values and meanings of other fields, please refer to corresponding fields in the sensing measurement poll trigger frame used to trigger the transmission of the uplink HE TB PPDU in the section 1.2 above.

### 3. Trigger Based Sensing Measurement Frame

The trigger based sensing measurement frame (TB Sensing NDP) is used in the trigger frame based sensing measurement phase, and its function is to implement the uplink concurrent channel estimation. The AP may simultaneously sense states of the channel with multiple STAs. The STA here may be the target STA of the sensing measurement trigger frame transmitted by the AP.

There are two variants of the sensing measurement frame, one is an EHT trigger based sensing measurement frame (e.g., an EHT TB Sensing NDP) applicable to the EHT STA, and the other is the HE trigger based sensing measurement (e.g., an HE TB Sensing NDP) applicable to HE STA frame.

### 3.1 EHT TB Sensing NDP

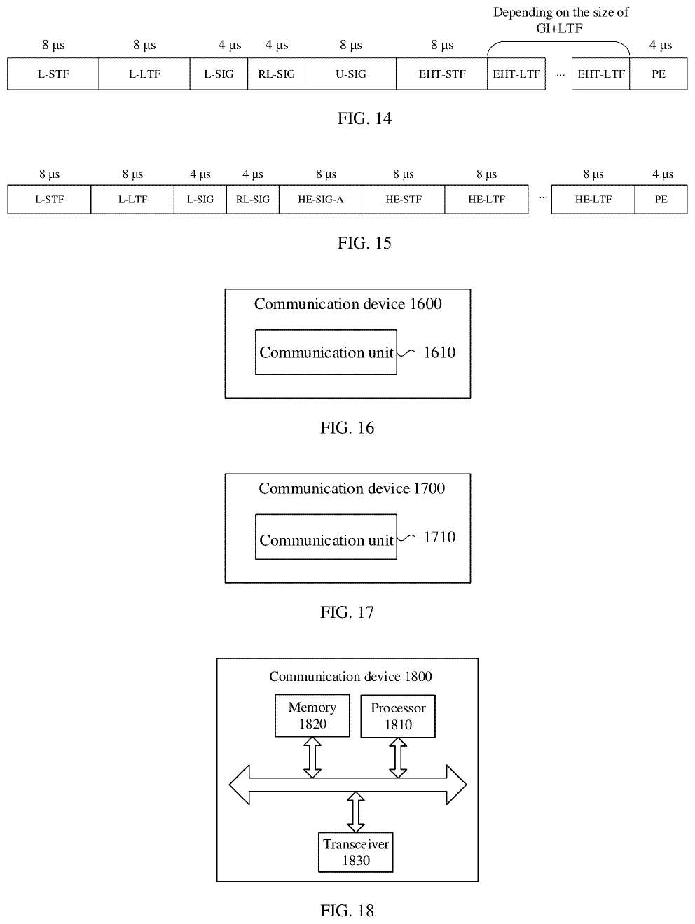

A format of the EHT TB Sensing NDP is shown in FIG. 14, including at least one of the following fields: the L-STF, the L-LTF, the L-SIG, the RL-SIG, the U-SIG, the EHT-STF, the PE, or the like. Examples of the duration of the above fields may include that: the duration of the L-STF is 8 μs, the duration of the L-LTF is 8 μs, the duration of the L-SIG is 4 μs, the duration of the RL-SIG is 4 μs, the duration of the U-SIG is 8 μs, the duration of the EHT-STF depends on the size of the GI and the LTE, and the duration of the PE is 4 μs.

The EHT TB Sensing NDP has the following characteristics:
the EHT TB Sensing NDP using the format of the EHT TB PPDU without the data (Data) field;
the waveform generated by the EHT TB Sensing NDP being not available for beamforming;
the EHT-STF field of the EHT TB Sensing NDP being the same as the EHT-STF field of the EHT TB PPDU;
the duration of the packet extension (Packet Extension, PE) field of the EHT TB Sensing NDP being 4 μs.

For the transmission of the EHT-LTF, when the number of transmit spatial streams (NSS)=the number of transmit chains (NTx), the spatial mapping matrix (Q matrix) is an identity matrix; when NSS<NTx, the Q matrix should be an antenna selection matrix without antenna switching; and when all 0 rows are deleted, the Q matrix should become the identity matrix.

The EHT-LTF supports 2×EHT-LTF+0.8 μs GI and 2×EHT-LTF+1.6 μs GI, may support 4×EHT-LTF+3.2 μs GI, and other types of the EHT-LTF types may be disallowed.

In the EHT TB Sensing NDP, the number of EHT-LTF symbols is the product of the normal number of the EHT-LTF symbols and the number of repetitions of the EHT-LTF. The number of repetitions of the EHT-LTF may be carried by the sensing measurement trigger frame in any one of the above embodiments.

### 3.2 HE TB Sensing NDP

A format of the HE TB Sensing NDP is shown in FIG. 15, including at least one of the following fields: the L-STF, the L-LTF, the L-SIG, the RL-SIG, the HE-SIG-A, the HE-STF, the HE-LTF, the PE, or the like. Examples of the duration of the above fields may include that: the duration of the L-STF is 8 μs, the duration of the L-LTF is 8 μs, the duration of the L-SIG is 4 μs, the duration of the RL-SIG is 4 μs, the duration of the HE-SIG-A is 8 μs, there may be multiple HE-STFs and the duration of each HE-STF is 8 μs, the duration of the HE-LTF is 8 μs, and the duration of the PE is 4 μs.

The HE TB Sensing NDP has the following characteristics:
the HE TB Sensing NDP using the format of the HE TB PPDU without the data (Data) field.
the Waveforms generated by the HE TB Sensing NDP being not available for beamforming.
the HE-STF field of the HE TB Sensing NDP being the same as the HE-STF field of the HE TB PPDU.
the duration of the packet extension (PE) field of the HE TB Sensing NDP being 4 μs.

For the transmission of the HE-LTF, when the number of transmit spatial streams (NSS)=the number of transmit chains (NTx), the spatial mapping matrix (Q matrix) is an identity matrix; when NSS<NTx, the Q matrix should be an antenna selection matrix without antenna switching; and when all 0 rows are deleted, the Q matrix should become the identity matrix.

The HE-LTF supports 2×HE-LTF+1.6 μs GI, and other types of the HE-LTF may be disallowed.

In the HE TB Sensing NDP, the number of HE-LTF symbols is the product of the normal number of the HE-LTF symbols and the number of repetitions of the HE-LTF. The number of repetitions of the HE-LTF may be carried by the sensing measurement trigger frame in any of the above embodiments.

The embodiments of the present application provide a new frame format used in the sensing measurement phase of the WIFI sensing. In the possible trigger frame based sensing measurement type, the following frame structures need to be used in the sensing measurement phase: the sensing measurement poll trigger frame, the sensing measurement trigger frame and the trigger based sensing measurement frame. The sensing measurement poll trigger frame may trigger the uplink EHT TB PPDU or the uplink HE TB PPDU. The sensing measurement trigger frame may trigger the uplink EHT TB Sensing NDP or the uplink HE TB Sensing NDP. Most trigger frame based sensing measurement tasks can be implemented by using at least one of these three frame structures.

FIG. 16 is a schematic block diagram showing a communication device 1600 according to an embodiment of the present application. The communication device 1600 may include: a communication unit 1610, configured to transmit and/or receive the trigger frame carrying the sensing measurement related information.

In a possible implementation, the sensing measurement related information includes the field for indicating the trigger frame type dependent common information.

In a possible implementation, the field for indicating the trigger frame type dependent common information includes the field for indicating the sensing trigger frame subtype.

In a possible implementation, the value of the field for indicating the sensing trigger frame subtype is the first value, indicating that the trigger frame is the sensing measurement poll trigger frame.

In a possible implementation, the sensing measurement poll trigger frame is used to trigger the transmission of the uplink extremely high throughput (EHT TB) trigger based physical layer protocol unit (PPDU).

In a possible implementation manner, the field for indicating the trigger frame type dependent common information is the field in the EHT variant common information field of the sensing measurement poll trigger frame.

In a possible implementation, the sensing measurement poll trigger frame is used to trigger the transmission of uplink high efficiency (HE) TB PPDU.

In a possible implementation, the field for indicating the trigger frame type dependent common information is the field in the HE variant common information field of the sensing measurement poll trigger frame.

In a possible implementation, the value of the field for indicating the sensing trigger frame subtype is the second value, indicating that the trigger frame is the sensing measurement trigger frame.

In a possible implementation, the sensing measurement trigger frame is used to trigger the transmission of the uplink EHT TB sensing measurement frame.

In a possible implementation, the field for indicating the trigger frame type dependent common information is the field in the EHT variant common information field of the sensing measurement trigger frame.

In a possible implementation, the field used to indicate the trigger frame type dependent common information further includes: the field for indicating the number of repetitions of the extremely high throughput long training field (EHT-LTF).

In a possible implementation, the field for indicating the number of repetitions of EHT-LTF is used to indicate the number of repetitions of the EHT-LTF in the EHT TB sensing measurement frame triggered by the sensing measurement trigger frame.

In a possible implementation, in the EHT variant common information field of the sensing measurement trigger frame, at least one of the following becomes the reserved field and/or is set to the third value: the LDPC extra symbol segment field, the FEC pre-filled factor field, or the PE disambiguation field.

In a possible implementation, in the EHT variant user information field of the sensing measurement trigger frame, at least one of the following becomes the reserved field and/or is set to the fourth value: the uplink forward error correction coding scheme field, the uplink EHT modulation or coding strategy field.

In a possible implementation, the sensing measurement trigger frame is used to trigger the transmission of the uplink HE TB sensing measurement frame.

In a possible implementation, the field for indicating the trigger frame type dependent common information is the field in the HE variant common information field of the sensing measurement trigger frame.

In a possible implementation, the field for indicating the trigger frame type dependent common information further includes: the field for indicating the number of repetitions of the HE-LTF.

In a possible implementation, the field for indicating the number of repetitions of the HE-LTF is used to indicate the number of repetitions of the HE-LTF in the HE TB sensing measurement frame triggered by the sensing measurement trigger frame.

In a possible implementation, in the HE variant common information field of the sensing measurement trigger frame, at least one of the following becomes the reserved field and/or is set to the fifth value: the LDPC extra symbol segment field, the FEC pre-filled factor field, the PE disambiguation field, the Doppler field, the uplink space time block coding field, or the MU-MIMO HE-LTF mode field.

In a possible implementation, in the HE variant user information field of the sensing measurement trigger frame, at least one of the following becomes the reserved field and/or is set to the sixth value: the uplink forward error correction coding scheme field, the uplink HE modulation and coding strategy field, or the uplink dual carrier modulation field.

In a possible implementation, the field for indicating the trigger frame type dependent common information further includes at least one of the following:
the field for indicating the sensing measurement setup identifier;
the field for indicating the sensing measurement instance identifier; or
the reserved field.

In a possible implementation, the field for indicating the sensing measurement setup identifier is used to identify and indicate the measurement parameter setup to be used by the sensing measurement instance.

In a possible implementation, the field for indicating the sensing measurement instance identifier increases by 1 from 0 to 255, and then starts from 0 after reaching 255.

The communication device 1600 in the embodiments of the present application can implement corresponding functions of the communication device in the embodiments of the method 800. For corresponding processes, functions, implementation methods and beneficial effects corresponding to each module (sub-module, unit or component) of the communication device 1600, please refer to corresponding description in the embodiments of the method, and will not be described again here. It should be noted that the functions described in each module (sub-module, unit or component) of the communication device 1600 in the embodiments of the present application may be implemented by different modules (sub-modules, units or components) or by the same module (sub-module, unit or component).

FIG. 17 is a schematic block diagram showing a communication device 1700 according to an embodiment of the present application. The communication device 1700 may include:
a communication unit 1710, configured to transmit and/or receive the trigger based sensing measurement frame.

In a possible implementation, the trigger based sensing measurement frame is used for the uplink concurrent channel estimation.

In a possible implementation, the trigger based sensing measurement frame is the EHT TB sensing measurement frame, and the EHT TB sensing measurement frame is used for the EHT (station) STA.

In a possible implementation, the EHT TB sensing measurement frame is in the format of the EHT TB PPDU without the data field.

In a possible implementation, the waveform generated by the EHT TB sensing measurement frame is not available for beamforming.

In a possible implementation, the EHT-STF field of the EHT TB sensing measurement frame is the same as the EHT-STF field of the EHT TB PPDU.

In a possible implementation, the duration of the packet extension field of the EHT TB sensing measurement frame is 4 μs.

In a possible implementation, the spatial mapping matrix used by the transmission of the EHT-LTF of the EHT TB sensing measurement frame is determined by using at least one of the following ways:
in a case where the number of spatial streams NSS which are transmitted is equal to the number of transmit chains NTx which are transmitted, the spatial mapping matrix being the identity matrix;
in a case where the NSS is less than the NTx, the spatial mapping matrix being the antenna selection matrix without antenna switching; or
in a case where all 0 rows are deleted, the spatial mapping matrix being the identity matrix.

In a possible implementation, the EHT-LTF in the EHT TB sensing measurement frame supports at least one of the following types:
2×EHT-LTF+0.8 μs GI;
2×EHT-LTF+1.6 μs GI; or
4×EHT-LTF+3.2 μs GI.

In a possible implementation, the number of EHT-LTF symbols in the EHT TB sensing measurement frame is the product of the normal number of the EHT-LTF symbols and the number of repetitions of the EHT-LTF.

In a possible implementation, the number of repetitions of the EHT-LTF is carried by the sensing measurement trigger frame, and the sensing measurement trigger frame is used to trigger the EHT TB sensing measurement frame.

In a possible implementation, the trigger based sensing measurement frame is the HE TB sensing measurement frame, and the HE TB sensing measurement frame is used for the HE STA.

In a possible implementation, the HE TB sensing measurement frame is in the format of the HE TB PPDU without the data field.

In a possible implementation, the waveform generated by the HE TB sensing measurement frame is not available for beamforming.

In a possible implementation, the HE-STF field of the HE TB sensing measurement frame is the same as the HE-STF field of the HE TB PPDU.

In a possible implementation, the duration of the packet extension (Packet Extension, PE) field of the HE TB sensing measurement frame is 4 μs.

In a possible implementation, the spatial mapping matrix used by the transmission of the HE-LTF of the HE TB sensing measurement frame is determined by using at least one of the following ways:
in a case where the number of spatial streams NSS which are transmitted is equal to the number of transmit chains NTx which are transmitted, the spatial mapping matrix being the identity matrix;
in a case where the NSS is less than the NTx, the spatial mapping matrix being the antenna selection matrix without antenna switching; or
in a case where all 0 rows are deleted, the spatial mapping matrix being the identity matrix.

In a possible implementation, the type supported by the HE-LTF in the HE TB sensing measurement frame is: 2×HE-LTF+1.6 μs GI.

In a possible implementation, the number of the HE-LTF symbols of the HE TB sensing measurement frame is the product of the normal number of the HE-LTF symbols and the number of repetitions of the HE-LTF.

In a possible implementation, the number of repetitions of the HE-LTF is carried by the sensing measurement trigger frame, and the sensing measurement trigger frame is used to trigger the HE TB sensing measurement frame.

The communication device 1700 in the embodiments of the present application can implement corresponding functions of the communication device in the embodiments of the method 900. For corresponding processes, functions, implementation methods and beneficial effects corresponding to each module (sub-module, unit or component) of the communication device 1700, please refer to the corresponding description in the embodiments of the method, and will not be described again here. It should be noted that the functions described in each module (sub-module, unit or component) of the communication device 1700 in the embodiments of the present application may be implemented by different modules (sub-modules, units or components), or by the same module (submodule, unit or component).

FIG. 18 is a schematic block diagram showing a communication device 1800 according to the embodiments of the present application. The communication device 1800 includes a processor 1810, and the processor 1810 may invoke and execute a computer program from a memory to enable the communication device 1800 to implement the methods in the embodiments of the present application.

In a possible implementation, the communication device further includes a memory 1820. The processor 1810 may invoke and execute the computer program from the memory 1820 to enable the communication device 1800 to implement the methods in the embodiments of the present application.

The memory 1820 may be a separate device independent from the processor 1810, or may be integrated into the processor 1810.

In a possible implementation, the communication device 1800 may further include a transceiver 1830, and the processor 1810 may control the transceiver 1830 to communicate with other devices. In some embodiments, the communication device 1800 may transmit information or data to other devices, or receive information or data transmitted by other devices.

Herein, the transceiver 1830 may include a transmitter and a receiver. The transceiver 1830 may further include an antenna, and the antenna may be singular or plural in number.

In a possible implementation, the communication device 1800 may be the communication device of the embodiments of the present application, and the communication device 1800 may implement the corresponding processes implemented by the communication device in each method 800 of the embodiments of the present application, which will not be repeated here for brevity.

In a possible implementation, the communication device 1800 may be the communication device of the embodiments of the present application, and the communication device 1800 may implement the corresponding processes implemented by the communication device in each method 900 of the embodiments of the present application, which will not be repeated here for brevity.

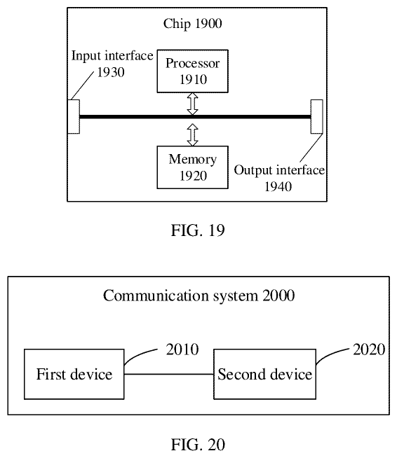

FIG. 19 is a schematic block diagram showing a chip 1900 according to the embodiments of the present application. The chip 1900 includes a processor 1910. The processor 1910 may invoke and execute a computer program from a memory to implement the methods in the embodiments of the present application.

In a possible implementation, the chip 1900 may further include a memory 1920. The processor 1910 may invoke and execute the computer program from the memory 1920 to implement the method executed by the communication device 1600 or the communication device 1700 in the embodiments of the present application.

The memory 1920 may be a separate device independent from the processor 1910, or may be integrated into the processor 1910.

In a possible implementation, the chip 1900 may further include an input interface 1930. The processor 1910 may control the input interface 1930 to communicate with other devices or chips. In some embodiments, the input interface 1930 may acquire information or data transmitted by other devices or chips.

In a possible implementation, the chip 1900 may further include an output interface 1940. The processor 1910 may control the output interface 1940 to communicate with other devices or chips. In some embodiments, the output interface 1940 may output information or data to other devices or chips.

In a possible implementation, the chip may be applied to the communication device 1600 in the embodiments of the present application, and the chip may implement the corresponding processes implemented by the communication device 1600 in various methods of the embodiments of the present application, which will not be repeated here for brevity.

In a possible implementation, the chip can be applied to the communication device 1700 in the embodiment of the present application, and the chip can implement the corresponding processes implemented by the communication device 1700 in the various methods of the embodiment of the present application, which will not be repeated here for brevity.

The same chip or different chips may be applied to the communication device 1600 and the communication device 1700.

It should be understood that the chip mentioned in the embodiments of the present application may also be called a system-level chip, a system chip, a chip system, or a system-on-chip.

The processor mentioned above can be a general-purpose processor, a digital signal processor (DSP), a field programmable gate array (FPGA), an application specific integrated circuit (ASIC) or other programmable logic devices, a transistor logic device, a discrete hardware component, or the like. The general-purpose processor mentioned above may be a microprocessor or any conventional processor.

The memory mentioned above may be volatile memory or non-volatile memory, or may include both volatile and non-volatile memory. Herein, the non-volatile memory can be a read-only memory (ROM), a programmable ROM (programmable ROM, PROM), an erasable programmable read-only memory (erasable PROM, EPROM), an electrically erasable programmable read-only memory (electrically EPROM, EEPROM) or a flash memory. The volatile memory may be a random access memory (RAM).

It should be understood that the above memory is an exemplary but not for limiting description. For example, the memory in the embodiments of the present application can also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM) a direct rambus random access memory (Direct Rambus RAM, DR RAM), or the like. That is, the memories in embodiments of the present application are intended to include, but are not limited to, these and any other suitable types of memories.

FIG. 20 is a schematic block diagram showing a communication system 2000 according to the embodiments of the present application. The communication system 2000 includes a first device 2010 and a second device 2020.

In an embodiment, the first device 2010 is configured to transmit the trigger frame carrying the sensing measurement related information. The second device 2020 is configured to receive the trigger frame carrying the sensing measurement related information. Herein, the first device 2010 may be used to implement the corresponding functions implemented by the first device, such as the AP, in the method 800, and the second device 2020 may be used to implement the corresponding functions implemented by the second device, such as the STA, in the method 800. Examples of the format of the trigger frame carrying the sensing measurement related information, please refer to the above method 800 and its related description, which will not be repeated here for brevity.

In another embodiment, the second device 2020 is configured to transmit the trigger based sensing measurement frame. The first device 2010 is configured to receive the trigger based sensing measurement frame. Herein, the first device 2010 may be used to implement the corresponding functions implemented by the first device, such as the AP, in the above 900, and the second device 2020 may be used to implement the corresponding functions implemented by the second device, such as the STA, in the method 900. For examples of the format of the trigger based sensing measurement frame, please refer to the method 900 and its related description, which will not be repeated here for brevity.

The above embodiments may be implemented in whole or in part through a software, a hardware, a firmware, or any combination thereof. When the above embodiments are implemented by using the software, they may be implemented in a form of a computer program product in whole or in part. The computer program product includes one or more computer instructions. When the computer program(s) are loaded on and executed by a computer, processes or functions according to the embodiments of the present application are generated in whole or in part. The computer may be a general-purpose computer, a dedicated computer, a computer network, or any other programmable device. The computer instructions may be stored in a non-transitory computer-readable storage medium, or transmitted from a non-transitory computer-readable storage medium to another non-transitory computer-readable storage medium. For example, the computer instructions may be transmitted from a website, computer, server or data center to another website, computer, server or data center via a wired manner (such as a coaxial cable, an optical fiber, or a digital subscriber line (Digital Subscriber Line, DSL)) or a wireless manner (such as infrared, wireless, or microwave). The non-transitory computer-readable storage medium may be any available medium that may be accessed by the computer, or a data storage device, such as a server or a data center, including one or more available media. The available medium may be a magnetic medium (e.g., a floppy disk, a hard disk or a magnetic tape), an optical medium (e.g., a DVD), a semiconductor medium (e.g., a solid state drive (Solid State Drive, SSD)), or the like.

It should be understood that, in the various embodiments of the present application, the magnitudes of the sequence numbers of the above-mentioned processes does not mean an order of execution, the order of execution of the processes shall be determined by their functions and inherent logic, and shall not constitute any limitation on the implementation processes of the embodiments of the present application.

It should be understood that, the various embodiments and features in the various embodiments of the present application may be combined with each other, provided that there is no conflict.

Those skilled in the art may clearly understand that, for convenience and simplicity of description, the working processes of the system, the device and the unit described above may refer to the corresponding processes in the above method embodiments, which will not be repeated here.

The above content is only an implementation of the embodiments of the present application, but the protection scope of the embodiments of the present application is not limited thereto, and any skilled familiar with this technical field may easily think of changes or substitutions within the technical scope disclosed in the embodiments of the present application, which should be all covered within the protection scope of the embodiments of the present application. Therefore, the protection scope of the embodiments of the present application should be subject to the protection scope of the claims.

What is claimed is:

1. A communication method, comprising:
transmitting and/or receiving, by a communication device, a trigger frame carrying sensing measurement related information.

2. The method of claim 1, wherein the sensing measurement related information comprises a field for indicating trigger frame type dependent common information.

3. The method of claim 2, wherein the field for indicating the trigger frame type dependent common information comprises a field for indicating a sensing trigger frame subtype.

4. The method of claim 3, wherein a value of the field for indicating the sensing trigger frame subtype is a first value, indicating that the trigger frame is a sensing measurement poll trigger frame.

5. The method of claim 4, wherein the sensing measurement poll trigger frame is used to trigger a transmission of an uplink extremely high throughput (EHT) trigger based (TB) physical layer protocol data unit (PPDU).

6. The method of claim 5, wherein the field for indicating the trigger frame type dependent common information is a field in an EHT variant common information field of the sensing measurement poll trigger frame.

7. The method of claim 4, wherein the sensing measurement poll trigger frame is used to trigger a transmission of uplink high efficiency (HE) TB PPDU.

8. The method of claim 7, wherein the field for indicating the trigger frame type dependent common information is a field in an HE variant common information field of the sensing measurement poll trigger frame.

9. The method of claim 3, wherein a value of the field for indicating the sensing trigger frame subtype is a second value, indicating that the trigger frame is a sensing measurement trigger frame.

10. The method of claim 9, wherein the sensing measurement trigger frame is used to trigger a transmission of an uplink EHT TB sensing measurement frame.

11. The method of claim 10, wherein the field for indicating the trigger frame type dependent common information is a field in an EHT variant common information field of the sensing measurement trigger frame.

12. The method of claim 10, wherein in an EHT variant common information field of the sensing measurement trigger frame, at least one of following becomes a reserved field and/or is set to a third value: a low density parity check code (LDPC) extra symbol segment field, a forward error correction (FEC) pre-filled factor field, or a packet extension (PE) disambiguation field.

13. The method of claim 9, wherein the sensing measurement trigger frame is used to trigger a transmission of an uplink HE TB sensing measurement frame.

14. The method of claim 13, wherein the field for indicating the trigger frame type dependent common information is a field in an HE variant common information field of the sensing measurement trigger frame.

15. The method of claim 13, wherein in an HE variant common information field of the sensing measurement trigger frame, at least one of following becomes a reserved field and/or is set to a fifth value: an LDPC extra symbol segment field, an FEC pre-filled factor field, a PE disambiguation field, a Doppler field, an uplink space time block coding field, or a multiple user multiple-input multiple-output (MU-MIMO) HE-LTF mode field.

16. A communication method, comprising:
transmitting and/or receiving, by a communication device, a trigger based (TB) sensing measurement frame.

17. The method of claim 16, wherein the trigger based sensing measurement frame is an EHT TB sensing measurement frame, and the EHT TB sensing measurement frame is used for an EHT station (STA).

18. The method of claim 17, wherein a spatial mapping matrix used by a transmission of an EHT-LTF of the EHT TB sensing measurement frame is determined in at least one of following ways:
in a case where a number of spatial streams (NSS) which are transmitted is equal to a number of transmit chains (NTx) which are transmitted, the spatial mapping matrix being an identity matrix;
in a case where the NSS is less than the NTx, the spatial mapping matrix being an antenna selection matrix without antenna switching; or
in a case where all zero rows are deleted, the spatial mapping matrix being an identity matrix.

19. A communication device, comprising:
a memory, configured to store a computer program; and
a processor, configured to invoke and execute the computer program stored in the memory, wherein the processor is configured to perform:
transmitting and/or receiving a trigger frame carrying sensing measurement related information.

20. A communication device, comprising: a processor and a memory, wherein the memory is configured to store a computer program, and the processor is configured to invoke and execute the computer program stored in the memory, enabling the communication device to perform the method of claim 16.
